(19) United States
(12) Patent Application Publication
(10) Pub. No.: US 2025/0074025 A1
(43) Pub. Date: Mar. 6, 2025

(54) Efficient Automated Box Former

(71) Applicant: Staples, Inc., Framingham, MA (US)

(72) Inventors: Harsha Amba, Thonotosassa, FL (US); Aum Patel, Thonotosassa, FL (US); Augustin Bernard, Holiday, FL (US); Garrett Johnson, Tampa, FL (US)

(21) Appl. No.: 18/822,136

(22) Filed: Aug. 31, 2024

Related U.S. Application Data
(60) Provisional application No. 63/579,881, filed on Aug. 31, 2023.

(51) Int. Cl. B31B 50/28; B31B 50/02; B31B 50/06; B31B 50/62

(52) U.S. Cl. CPC B31B 50/28; B31B 50/022; B31B 50/06; B31B 50/624

(57) ABSTRACT

A box former may include a carton blank dispensing device that holds a carton blank and carton moving devices that move the carton blank from the carton blank dispensing device and positions it between a plunger and a forming well. The forming well may include a floor, one or more walls, and an opening. The plunger may be configured to move between a retracted position and one or more extended positions, the plunger contacting a top surface of the carton blank and pushing the carton blank into the forming well through the opening of the forming well. In some implementations, the box former may include forming guides that contact points on a bottom surface of the carton blank when it is pushed by the plunger to cause the carton blank to fold into a formed carton.

### BACKGROUND

This application relates to warehouse fulfillment systems. For example, this application relates to an automated, efficient box former for making boxes.

Previous box erector systems had numerous issues that made them difficult or costly to use in warehouses or fulfillment centers in which space, speed, automation, and cost are important. For example, these previous systems required significant amounts of floor space, so only a single box erector making a single box size could fit. Previous box erectors required multiple mechanical and/or human operations to erect boxes, which resulted in increased space usage, cost, complexity, and other issues.

Some box erector systems were not automated or required one or more human operations, and they required pre-construction and then folding of boxes. For instance, previous systems required that a cardboard manufacturer fold and glue, staple, or tape one or more sides of the box, which pre-manufactured boxes are then later unfolded folded and erected at a fulfillment center. Unfortunately, these boxes are bulky, expensive, and inefficiently use space and materials. Similarly, they may be only partially erectable by machinery and/or may require human interaction.

These previous systems may only be useful for a single box size due to their multi-step nature and complexity be built for a single box size. They may not be adaptable without redesign and replacement of significant components.

Accordingly, existing mechanical box erectors tend to require specialized boxes, multiple operations, and are expensive, among other shortcomings.

### SUMMARY

A robotic box forming and fulfillment system can be configured to perform particular operations or actions by virtue of having software, firmware, hardware, or a combination of them installed on the system that in operation causes or cause the system to perform the actions. Similarly, various hardware components are described that improve the creation and automation of the box forming process.

In some aspects, the techniques described herein relate to a system including: a carton blank dispensing device that holds a carton blank; one or more carton moving devices that move the carton blank from the carton blank dispensing device and positions the carton blank between a plunger and a forming well; the forming well including a floor, one or more walls, and an opening; the plunger configured to move between a retracted position and one or more extended positions, the plunger contacting a top surface of the carton blank and pushing the carton blank into the forming well through the opening of the forming well; and a set of forming guides positioned proximate to the opening of the forming well, the set of forming guides contacting one or more points on a bottom surface of the carton blank when it is pushed by the plunger, the bottom surface opposing the top surface of the carton blank.

In some aspects, the techniques described herein relate to a system, wherein the carton blank dispensing device includes: a magazine holding a plurality of carton blanks, each of the plurality of carton blanks including a flat sheet of material with a plurality of cuts along a periphery of the flat sheet of material.

In some aspects, the techniques described herein relate to a system, wherein the one or more carton moving devices include: a carton conveyance mechanism that translates the carton blank horizontally to a position between the plunger and the forming well.

In some aspects, the techniques described herein relate to a system, wherein the one or more carton moving devices include: a carton grabber that transports the carton blank from the carton blank dispensing device to the carton conveyance mechanism including extracting the carton blank from the carton blank dispensing device.

In some aspects, the techniques described herein relate to a system, further including: an adhesive applicator that applies adhesive to the carton blank when the carton blank is connected to the carton conveyance mechanism.

In some aspects, the techniques described herein relate to a system, wherein the plunger includes: an actuator that moves the plunger between the retracted position and the one or more extended positions; a bottom plate that applies a force to the top surface of the carton blank; and a side pusher that allows compression of one or more side walls of a carton formed by the carton blank while the formed carton is in the forming well.

In some aspects, the techniques described herein relate to a system, wherein the set of forming guides includes: a plurality of forming guides positioned proximate to the opening of the forming well, the plurality of forming guides contacting a plurality of points on the bottom surface of the carton blank.

In some aspects, the techniques described herein relate to a system, wherein: the plurality of forming guides are positioned at a plurality of heights above the floor of the forming well to contact the plurality of points at different vertical positions as the plunger moves from the retracted position to the one or more extended positions, the plunger pushing the top surface of the carton blank through the opening of the forming well.

In some aspects, the techniques described herein relate to a system, wherein the one or more extended positions of the plunger include: a first extended position causing the bottom surface of the carton blank to contact a first forming guide and causing a first fold in the carton blank; and a second extended position causing the bottom surface of the carton blank to contact a second forming guide and causing a second fold in the carton blank.

In some aspects, the techniques described herein relate to a system, wherein: the plurality of forming guides have adjustable positions to allow the plurality of forming guides to fold different sized cartons using different configurations of carton blanks.

In some aspects, the techniques described herein relate to a system, further including: a pusher including a horizontally movable member that pushes a formed box out of the forming well, the formed box including the carton blank with one or more folds and an adhesive.

In some aspects, the techniques described herein relate to a system, wherein the carton blank includes: a flat sheet of material with a plurality of cuts along a periphery of the flat sheet of material.

In some aspects, the techniques described herein relate to a system, wherein: the flat sheet of material includes a zero folds when in the carton blank dispensing device.

In some aspects, the techniques described herein relate to a method including: receiving a carton blank at a box former; moving the carton blank to a position between a plunger and a forming well using one or more carton moving devices, the forming well including a floor, one or more walls, and an opening; and folding the carton blank into a folded carton by moving the plunger between a retracted position and one or more extended positions including pushing the carton blank into the forming well through the opening of the forming well, a set of forming guides being positioned proximate to the opening of the forming well, the set of forming guides contacting one or more points on a bottom surface of the carton blank when a top surface of the carton blank is pushed by the plunger, the bottom surface opposing the top surface of the carton blank.

In some aspects, the techniques described herein relate to a method, wherein folding the carton blank includes: moving the plunger from a first extended position to push a top surface of the carton blank until a first forming guide contacts a first point on a bottom surface of the carton blank, the bottom surface of the carton blank opposing the top surface of the carton blank, the first forming guide pushing against the first point and causing one or more side flaps of the carton blank to fold.

In some aspects, the techniques described herein relate to a method, wherein folding the carton blank includes: moving the plunger to a second extended position to push the top surface of the carton blank until a second forming guide contacts a second point on the bottom surface of the carton blank, the second forming guide pushing against the second point and causing one or more of a front and a back coupled with the one or more side flaps of the carton blank to fold.

In some aspects, the techniques described herein relate to a method, wherein folding the carton blank includes: moving the plunger to a third extended position to push the top surface of the carton blank until a third forming guide contacts a third point on the bottom surface of the carton blank, the third forming guide pushing against the third point and causing one or more sides of the carton blank to fold.

In some aspects, the techniques described herein relate to a method, further including: applying adhesive to one or more surfaces of the carton blank; and setting the adhesive by compressing the one or more surfaces of the carton blank when the carton blank is located in the forming well.

In some aspects, the techniques described herein relate to a carton blank including: a flat sheet of material including: a rectangular shape with a front edge, a back edge opposing the front edge, a left side edge extending between the front edge and the back edge, and a right side edge extending between the front edge and the back edge and opposing the left edge; two cuts starting on each of the back edge, front edge, left edge, and right edge and extending partially across the flat sheet of material to a plurality of end points, each of the cuts having a separate end point; and a plurality of creases extending between at least two of the end points of the cuts.

In some aspects, the techniques described herein relate to a carton blank, wherein: the material includes corrugated cardboard; and the cuts are die cut into the corrugated cardboard.

Other implementations of one or more of these aspects include corresponding systems, apparatus, and computer programs, configured to perform the actions of the methods, encoded on computer storage devices.

It should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 depicts an example system and data communication flow for implementing an automated robotic box forming and fulfilment system.

FIG. 2A illustrates an example layout of a set of box formers, which may be present in an area of a fulfillment center and used in the automated robotic fulfillment system.

FIGS. 2B and 2C illustrate perspective views of a pair of box formers in implementations contexts.

FIG. 3 is a flowchart of an example method for forming cartons or boxes using carton blanks or other sheets of material.

FIGS. 4A-4G illustrate example implementations of a box former with an example top-loading magazine.

FIGS. 5A-5F illustrate example implementations of a box former with an example side-loading magazine.

FIG. 5G illustrates an example cart magazine in a zoomed in or expanded view to show additional detail.

FIG. 5H illustrates an empty example cart magazine docked at a box former.

FIG. 5I illustrates an example lifter coupled with a side of a box former.

FIGS. 6A and 6B illustrate an example box former with components omitted for clarity and discussion purposes.

FIG. 6C also illustrates portions of an example box former with a door of a forming well in an open position.

FIGS. 6D and 6E illustrate views of an example forming well and forming guides.

FIG. 6F illustrates example adjustable rails and sets of forming guides mounted to the rails.

FIG. 6G illustrates an example plunger assembly, which may be used to push a bottom surface of a carton blank into a forming well.

FIG. 6H shows an example box former with a magazine and other devices omitted.

FIG. 6I illustrates a portion of an example box former with an example lifting device and cart magazine.

FIG. 6J illustrates an example implementation of a cart magazine.

FIG. 6K illustrates an example cart magazine located at a lifter of a box former.

FIG. 6L illustrates example components of a lifter that lifts a cart magazine and/or stack of carton blanks.

FIG. 6M illustrates an example carton grabber assembly.

FIGS. 7A-7F illustrate example operations of a box former in an example sequence, according to some implementations.

FIGS. 8A-8G describe various example implementations of an improved carton blank and formed carton.

FIG. 9 is a block diagram illustrating an example computing system, which may control a box former.

### DESCRIPTION

The technology described herein may be used in an automatic, robotic replenishment, organizing, or fulfillment system in a warehouse. For instance, the technology described herein may be applied in various contexts to quickly form and/or erect a box, for example, the technologies include box, case, or carton erectors or formers, an improved box design, and other technologies. It should be noted that boxes may take various forms and have various materials without departing from the scope of this disclosure. The example boxes are described herein as cardboard cartons, although other types and materials may be used. The improved boxes described herein also provide numerous advantages in cost, use, construction, and storage, for instance. These boxes may have various sizes, materials, or configurations and may be used with other types of box erectors or formers without departing from the scope of the technology.

The technology described herein provides example implementations of a mechanical box former that may form boxes in a single or few steps and may have improved automation and/or simplicity. The technology may include improved cardboard blanks and a process for forming them into cardboard boxes/cartons. For instance, the system may use a single stroke to perform a two or three stage folding process thereby reducing operations required to build a box and improving efficiency.

The technology described herein may provide a more-cost effective box former that occupies a smaller physical footprint thereby allowing multiple box formers to be used in a single facility or along a single length of conveyor. For example, the box former may be one half of the footprint of prior box erectors. The cost of the system itself may be significantly reduced, while the cost of a box, such as the example die cut carton blank described herein, may reduce cardboard waste, reduce costs by 20-30 percent, and provide numerous benefits. For instance, the system allows boxes to be formed without the cardboard manufacturer having to pre-assemble portions of the box.

The technology may include allow a box former 140 to be fully or partially automated so that when the fulfillment center (e.g., by the warehouse execution system or warehouse management system described below) transmits a request to an equipment controller 110 for a certain size box, the equipment controller 110 may operate a box former 140 set at a defined box size to automatically form and output a box (e.g., onto a conveyor 218). In some instances, a box former 140 may also include or be associated with an automatic label applicator (e.g., in or adjacent to the box former 140) or label scanner that allows individual boxes to be identified elsewhere in a fulfillment center. For instance, a particular size box may be output by a particular box former 140, labeled, and the label or license plate number on the box may be used to track or use the box (and/or orders/items placed in the box) elsewhere in the warehouse or fulfillment center. For example, an adjacent conveyor 218 or an AGV 114 may automatically convey the boxes downstream (e.g., for processing, receiving picks, on a conveyor, etc.) where they receive items for orders. Box sizes or configurations may be tracked by the warehouse execution system, for instance, by scanning the applied/scanned labels on the boxes at other locations in the warehouse thereby improving automation and the ability to accurately pick items into the correct boxes.

Various operations, features, and components for implementing the technology are described throughout this disclosure, such as in reference to the examples illustrated in the figures.

The technology described herein relates to an automated system comprising various software and hardware devices, for example, an automated robotic replenishment system, which may incorporate a manual or fully or partially automated box former/erector 140. The technology may include beneficial configurations, operations, features, and interactions. Among other benefits, the technology described herein improves upon that described in the Background Section. For instance, the technology provides robotic devices, systems, methods, and other aspects that can more efficiently form and use boxes, such as cardboard shipping cartons.

In some implementations, the technology may provide integration, coordination, and control of various systems to intelligently move items and reduce human interaction, which increases speed and accuracy.

In some instances, the technology may include various computing devices or controllers coupled with equipment, such as robotic arm(s), optical sensors or cameras, AGV(s) 114, other equipment, sensors (e.g., optical sensors, scanners, etc.) human interface system(s) 108, and other devices. In some implementations, the components may communicate with each other directly, for instance, via a network or communication bus. In some implementations, a central control system, such as a warehouse management system (WMS) 104 or other system may receive signals, perform computations, and issue commands to other devices.

Features of the technology described herein can be integrated into any logistics system, dispatch system 106, warehouse execution system 102, warehouse management system 104, a robot execution server 118, etc., to coordinate the operations of various systems, information, and devices in a fulfillment system. The technology described herein may provide a fully or partially automated system that provides redundancy, reduces the number of operations, and provides many other benefits described herein. The technology beneficially improves productivity and throughput, increases asset utilization, and lowers cycle time and labor costs. These benefits, in turn, lead to shorter delivery times and result in significant time and resource savings along with reduced error rates.

With reference to the figures, reference numbers may be used to refer to example components found in any of the figures, regardless of whether those reference numbers are shown in the figure being described. Further, where a reference number includes a letter referring to one of multiple similar components (e.g., component 000a, 000b, and 000n), the reference number may be used without the letter to refer to one or all of the similar components.

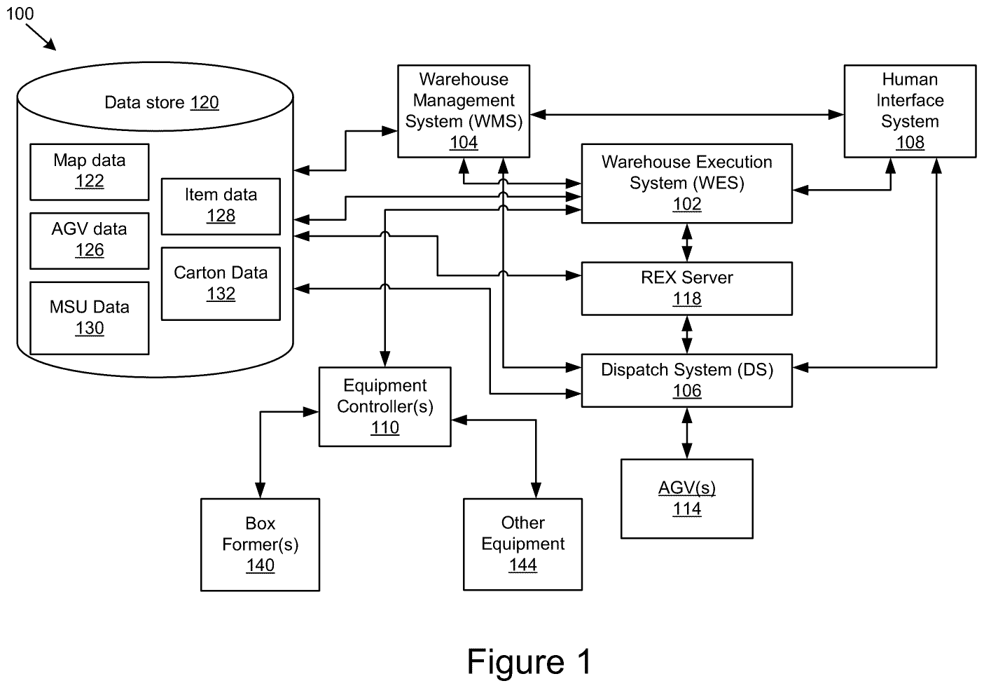

FIG. 1 depicts an example system 100 and data communication flow for implementing an automated fulfillment system, which may use the boxes and/or box formers 140 described in further detail herein. The system 100 includes a warehouse execution system (WES) 102. The WES 102 is coupled to equipment controller(s) 110, a warehouse management system (WMS) 104, a data store 120 storing various data, a human interface system 108 (e.g., pick-to-voice, pick-to-light, graphical user interface(s), etc.), a robot execution server (REX) 118, a dispatch system 106, and other systems. For instance, the system 100 may include box erector(s) 140 or other systems, and/or other equipment 144, such as optical sensors or cameras, printers, conveyors 218, robots, or other devices.

The WES 102 may, in some implementations, include one or more hardware and/or virtual servers programmed to perform operations, acts, and/or functionality described herein. For instance, the components of the WES 102 may comprise software routines storable in one or more non-transitory memory devices and executable by one or more computer processors of the WES 102 to carry out operations, acts, and/or functionality described herein. In further implementations, these routines, or a portion thereof, may be embodied in electrical hardware that is operable to carry out the operations, acts, and/or functionality described herein.

For example, the WES 102 may be communicatively coupled with scanner(s), carton conveyor(s) 218, item conveyor(s) 218, diverter(s), box former(s) 140, camera(s), and other equipment either directly or via the equipment controller(s) 110, which may be programmable logic controllers (e.g., conveyor controllers, conveyor scanner controllers, automated induction equipment controllers 110, other warehouse equipment controllers 110, or other computing devices for controlling equipment).

In some implementations, the WES 102 may receive, process, and transmit data to control software and hardware interactions, for example, by consolidating and controlling information across systems, as described herein. For instance, the WES 102 may serve as a decision point or control software that processes data streams for receiving data, processing the data, instructing devices, and other computations, as noted herein. For example, the WES 102 may communicate with equipment controller(s) 110 and/or other systems to receive scan data, move items (e.g., using a conveyance device), control a box former 140, move mobile storage units, or other operations. One or more of these operations may be performed via communication with various equipment of the system 100, as described in further detail herein. Accordingly, the WES 102 may provide unified communication that coordinates various systems.

The WES 102 and/or WMS 104 (together or separately) may communicate with various other systems and devices to perform its operations, as described herein, such as equipment controller(s) 110 and equipment. The WES 102 or WMS 104 may communicate with equipment or a human-interface system 108, which may provide operations for picking items, for instance.

The other equipment 144 may include an item handling station (e.g., where items are placed on a conveyor belt), other box erectors, label applicators, scanners, picking equipment, or other devices for inducting or moving items, mobile storage units, cartons, or other objects in the system; scanners that may include optical, radio, or other scanners or sensors that scan items, containers, totes, mobile storage units, or cartons to identify them; conveyors (e.g., 218) that may include one or more conveyor belts or other devices that convey objects (e.g., items, mobile storage units, cartons, boxes, or other objects), for instance, as described herein Other equipment 144 may include various other devices, such as label applicators, carton-closing equipment, control systems, printers, actuators, motors; or various other devices.

The REX server 118 may, in some implementations, include one or more hardware and/or virtual servers programmed to perform operations, acts, and/or functionality described herein. The REX server 118 may generate a schedule that defines the route for an AGV 114. For a given AGV 114, the REX server 118 may generate an AGV 114 schedule and transmit it to the dispatch system 106, which in turn deploys an AGV 114 according to the schedule or instruction, for instance. In some implementations, the dispatch system 106 instructs the AGV 114 to proceed through one or more areas of the distribution facility according to the schedule/instruction. The schedule of each of the AGVs 114 may be coordinated such that an optimal flow can be achieved.

In some implementations, the REX server 118 may include or may communicate with a routing engine, which may route AGVs 114 and/or objects (e.g., items, mobile storage units, etc.) in a fulfillment center.

The dispatch system 106 may be electronically communicatively coupled to a plurality of automated guided vehicles (AGVs) 114. In some implementations, the dispatch system 106, or elements thereof, may be integrated with or communicatively coupled with the REX server 118. The dispatch system 106 includes hardware and software configured to dispatch the AGVs 114 and is coupled for communication the components of the system 100 to receive instructions and provide data. The dispatch system 106 may calculate a route to execute the task considering traffic and resources. In some cases, it adjusts the route or the task in order to make the route efficient.

The AGVs 114 may be robotic vehicles including drive units providing motive force for moving the AGVs 114 (and, in some instances, items, storage units, etc.), guidance systems for determining position of the AGVs 114 within the distribution facility, and equipment for carrying items. Some AGVs 114 may be attached to, include, or carry carts, which, in turn, carry items or storage units.

The WMS 104 may, in some implementations, include one or more hardware and/or virtual servers or software routines storable in one or more non- transitory memory devices and executable by one or more processors to perform operations, acts, and/or functionality described herein. The WMS 104 may be configured to store and maintain data in the data store 120. In some implementations, the WMS 104 may be configured to communicate with the WES 102, the human interface system 108, dispatch system 106, and/or other systems in real time, in batches, as requested by these components, etc. For example, the WMS 104 may receive data from an e-commerce or other server, process the data, and update various data in the data store 120 based on the order data. Similarly, the WMS 104 may detect and update inventory and other data.

It should be noted that operations described herein in reference to the WMS 104 may be performed by other devices or by other components of the system 100. Similarly, it should be noted that the operations described in reference the WMS 104 and the other components of the system 100 may be distributed or shifted among the components of the system without departing from the scope of this disclosure. For instance, some operations described in reference to the WES 102 or WMS 104 may be performed by the equipment controller(s) 110 or REX server 118, or some operations described in reference to the equipment controller(s) 110, REX server 118, or automated box former(s) 140 may be performed by the WMS 104 or WES 102.

The human interface system 108 may, in some implementations, include one or more hardware and/or virtual servers or software routines storable in one or more non-transitory memory devices and executable by one or more processors to perform operations, acts, and/or functionality described herein. The human interface system 108 may provide instructions and/or receive data (e.g., scan data, user input, confirmations), for example, from human agents or operators (e.g., using barcode scanners, NFC, RFID or radio-frequency identification chips, or other sensors or input methods), as described in further detail below. An example human interface system 108 may include audio, illumination, or a graphical user interface system that receives inputs and/or provides instructions to human agents. The human interface system 108 may be configured to communicate the data with the WES 102, WMS 104, or other components of the system in real time, in batches, as requested by the components of the system, etc.

The human interface system 108 may receive scan data from a client device based on a user scanning a barcode or other identifier of an item, conveyance device 230, tote, etc. The human interface system 108 may provide instructions to users indicating to place certain items, totes, containers, mobile storage units, etc., at certain locations, remedy errors or exceptions, or perform other actions. For instance, the human interface system 108 may instruct a user to dump a container of items into a certain tote/conveyance device 230 for a certain automated carton erector 140, remedy an error at an automated carton erector 140 or AGV 114, or perform other actions.

In some implementations, for example, an equipment controller 110 may detect that a quantity of box/carton blanks 204 in a magazine 206 is low or empty at a box former 140, in which instance, the equipment controller 110 may communicate with the human interface system 108 (directly or via another component of the system 100) to instruct a human agent to reload the materials into the box former(s) 140 or perform other operations. In some instances, the reloading or other operation of the box formers 140 may be performed by other robotics, such as a robotic arm, humanoid robot, AGV 114 (e.g., where an AGV 114 is instructed to bring a cart magazine 206 to the box former 140 filled with box components/blanks), or other device.

The data store 120 is an information source for storing and providing access to data. The data stored by the data store 120 may be organized and queried using various criteria including any type of data stored by it. The data store 120 may include data tables, databases, or other organized collections of data. An example of the types of data stored by the data store 120 may include, but is not limited to map data 122, pallet data, AGV data 126, item data 128, MSU (mobile storage unit) data, carton data 132, or other data. In some instances, the data store 120 may also include system attributes, sensor data, labels, system health, etc.

The data store 120 may be included in the WES 102, WMS 104, equipment controller(s) 110, REX server 118, or in another computing system and/or storage system distinct from but coupled to or accessible by the WES 102, WMS 104, REX server 118, equipment controller(s) 110, or other components of the system 100. The WES 102, WMS 104, human interface system 108, REX server 118, and/or dispatch system 106, for example, may store and maintain data in the data store 120. The data store 120 can include one or more non-transitory computer-readable mediums for storing the data. In some implementations, the data store 120 may store data associated with a database management system (DBMS) operable on a computing system. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The map data 122 may include data reflecting the 2- or 3-dimensional layout of the facility including example locations of storage units, automated carton former(s)/erector(s) 140, container receiving areas/spaces, mobile storage unit receiving area/spaces, staging area(s), equipment, storage shelving units, items, AGVs 114, conveyors, etc. Map data 122 may indicate the attributes of the distribution facility, including attributes of zones/areas of a warehouse. For example, attributes of zones may include the number, quantity, and location of shelving units or bays, storage units, items, boxes/cartons, guidance system locators or markers, etc.

The AGV data 126 may describe the state of an AGV 114, such as operational state, health, location, battery life, storage capacity, objects (e.g., items, mobile storage units, totes, pallets, etc.) being carried, cartons, whether a picker is assigned to it, etc.

The item data 128 may describe items in a distribution facility. The item data 128 may include unique identifiers for these items, the item volume (e.g., the total amount picked in given window (e.g., in an hour, day, etc.)), the item velocity (e.g., number of different times item picked in given window (e.g., per hour, day etc.), the location of the items within the distribution facility (aisle, shelf, shelf position, mobile storage unit, mobile storage unit partition, tote, conveyance device 230, pallet, etc.), other attributes of the item (e.g., size, description, weight, quantity of items in a package, color, quantity of packages in a container, etc.), item inventory, or mapping of items to storage units, orders, conveyor locations, automated carton erector(s) 140, pallets, totes, etc. In some implementations, the item data 128 may include the quantity of particular items a storage unit contains, the current location of a storage unit, a storage location of items and/or storage units, and other data. For instance, the item data 128 may include visual aspects, labels, QR codes, identifying markers, etc., that may be used by the WES 102, WMS 104, or equipment controller(s) 110, etc., to identify items, for example, based on a scan of an item.

The MSU data 130 may include information about mobile storage units and/or containers in the system, such as a unique identifier or license plate number for each mobile storage unit or container, a mobile storage unit or container type, the zones a mobile storage unit will visit, the current or assigned location of a mobile storage unit, and the priority for the mobile storage unit. The MSU data 130 may include a list indicating the items, item types, and/or the quantity of items a mobile storage unit (or a partition thereof) contains or should contain (e.g., it's maximum or assigned capacity).

The carton data 132 may include various attributes describing box formers 140, available box sizes, box sizes associated with a box former 140, the state of each box former 140, box former 140 queues, or other data described herein.

The components of the system 100 may be coupled to exchange data via wireless and/or wired data connections. The connections may be made via direct data connections and/or a computer network. The computer network may comprise any number of networks and/or types of networks, such as wide area networks, local area networks, virtual private networks, cellular networks, close or micro proximity networks (e.g., Bluetooth, NFC, etc.), etc. In some implementations, one or more of these components may be coupled via a data communications bus.

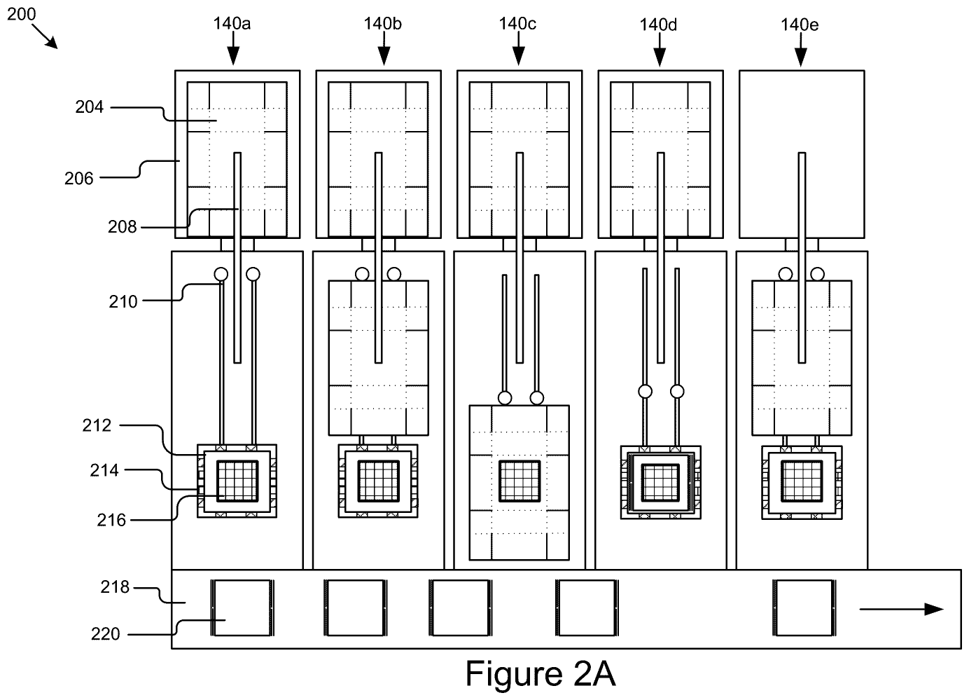

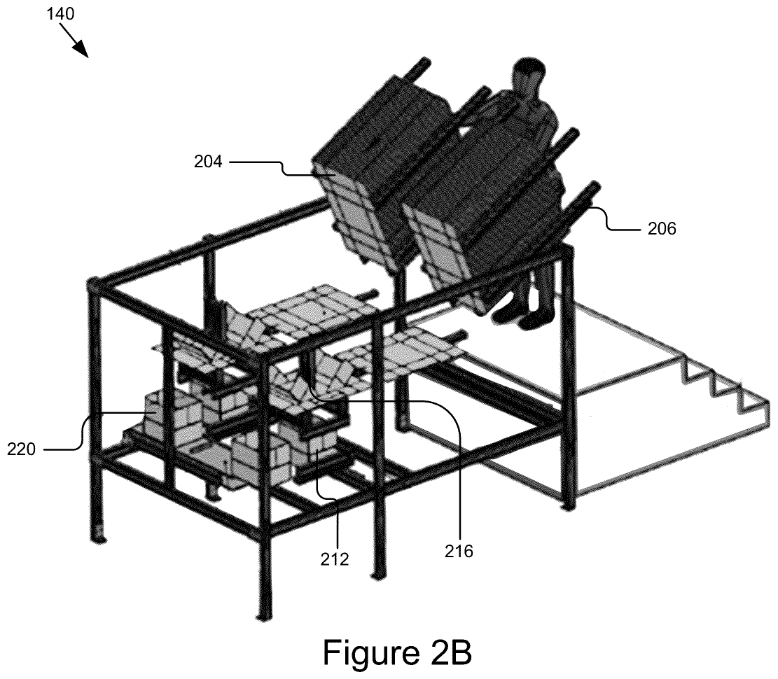

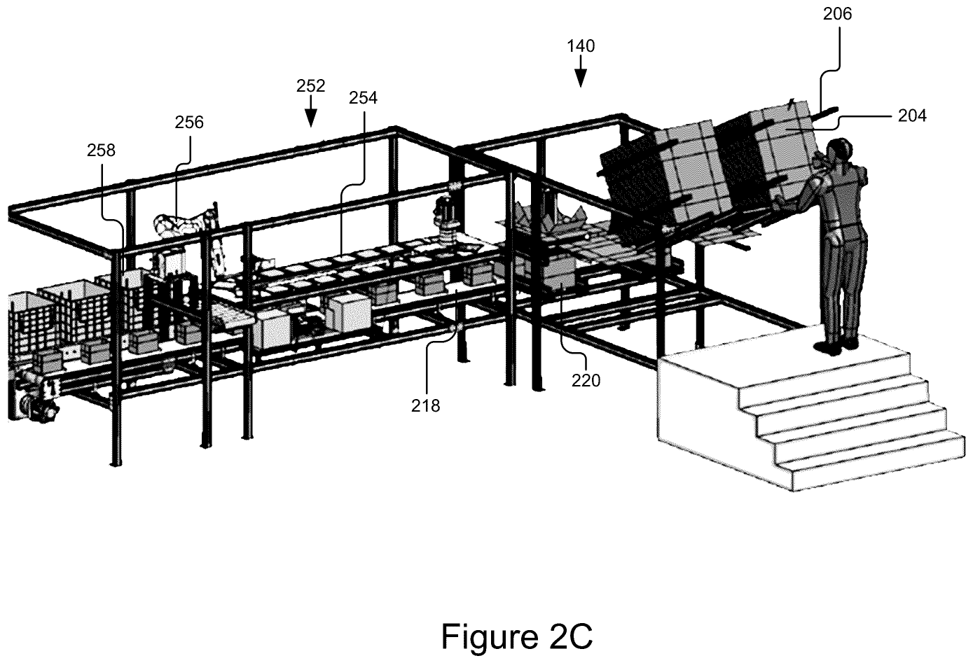

FIG. 2A illustrates an example layout 200 of a set of box formers, which may be present in an area of a fulfillment center and used in the automated robotic fulfillment system. For instance, the layout 200 illustrates a top-down view of a set of five example box formers 140a-140e positioned along a conveyor 218, which may feed downstream into other components of the system, such as picking stations, carousel picking station, pick-to-cart systems, automated sorting systems with diverters moving items and/or boxes, or otherwise. It should be noted that the layout 200 is provided as an illustrative example of how the technology described herein could be used and that other layouts, configurations, and uses may be used. For example, the layout 200 of FIG. 2A illustrates 5 detached, adjacent box formers 140a . . . 140e that show various operations of a box former 140. FIGS. 2B and 2C also illustrate other example layouts using box formers 140.

It should be understood that various facilities may include different configurations. For instance, a fulfillment center, distribution facility, or other location may use some or all of the aspects of the example layout. It should be noted that other configurations, components, or layouts are possible and contemplated herein, and the examples of FIGS. 2A-2C are provided by way of illustration.

The example layout and components of FIGS. 2A-2C may allow automated operations, as described in further detail in reference to the figures below. Example features of the layout provide various benefits, for example, as described above. The WMS 104 may use multiple parallel processes and/or equipment to intelligently schedule, spit, and coordinate tasks.

In the illustrated example layout 200, five box formers 140 are illustrated in a row along a single conveyor 218 belt, but other implementations are possible and contemplated, such as where multiple conveyors 218 with multiple branches are used, box formers 140 flank a conveyor 218, box formers 140 feed onto a ramp or set of AGVs 114, a single box former 140 is used, etc. Additionally, while the box formers 140 are illustrated as having a single configuration, they may have varying configurations, provide different sized boxes, etc. Similarly, they may share one or more components, such as a label applicator, conveyor 218, restocking agent (whether human or robotic), equipment controller 110/computing device, etc.

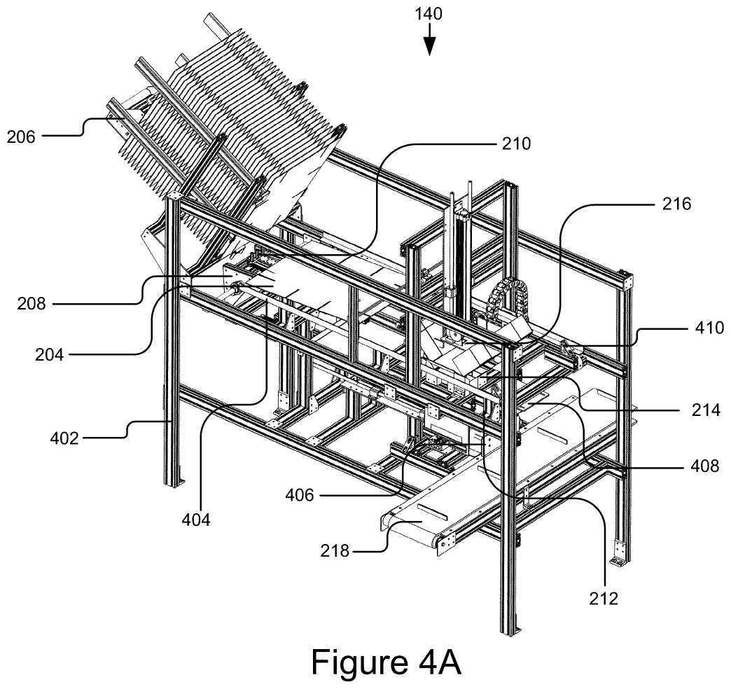

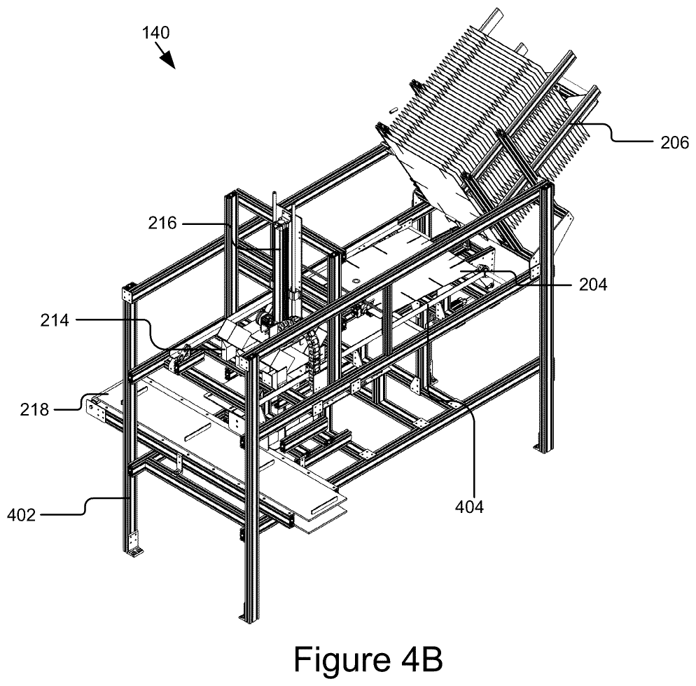

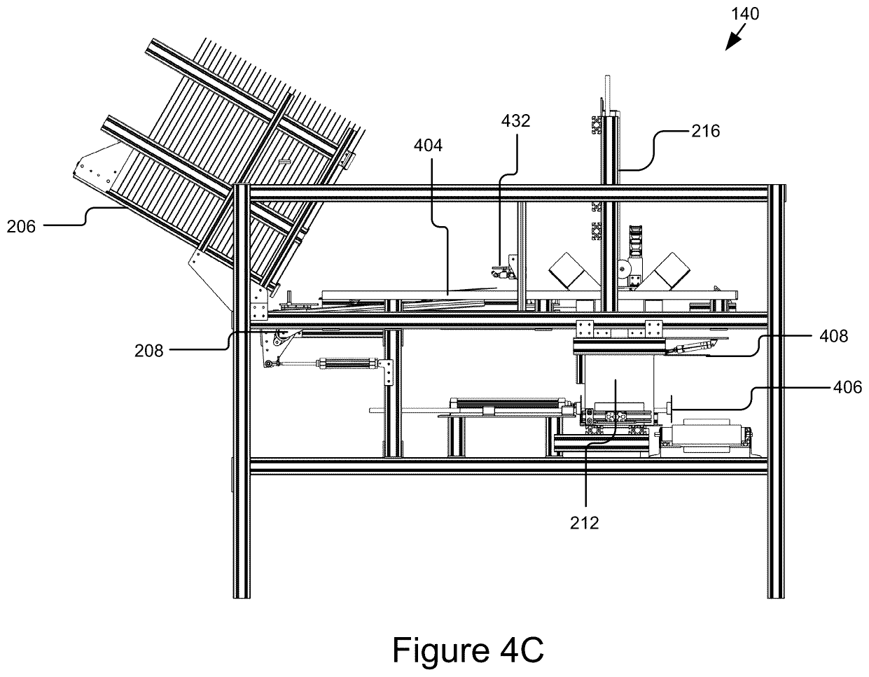

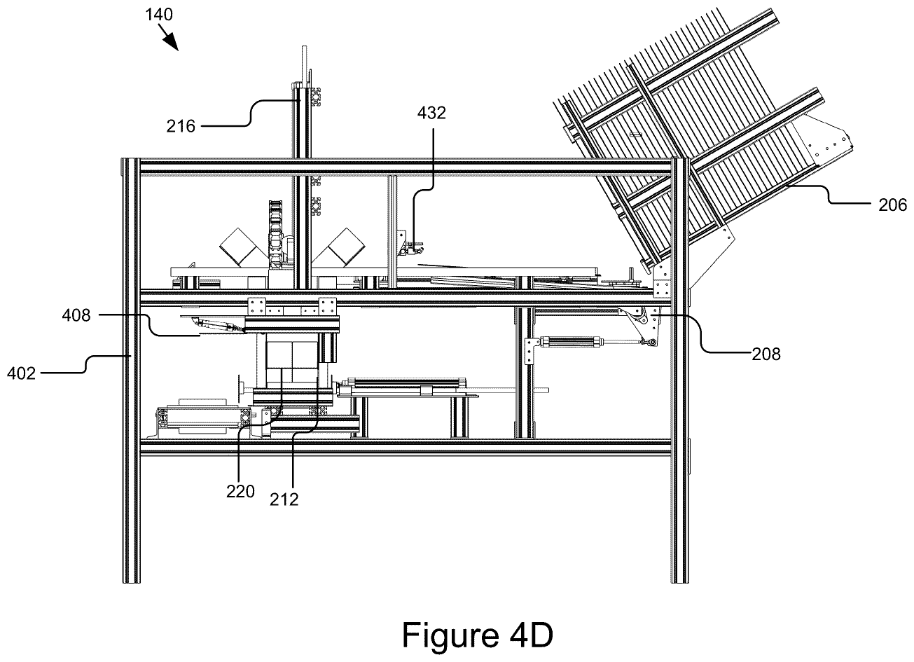

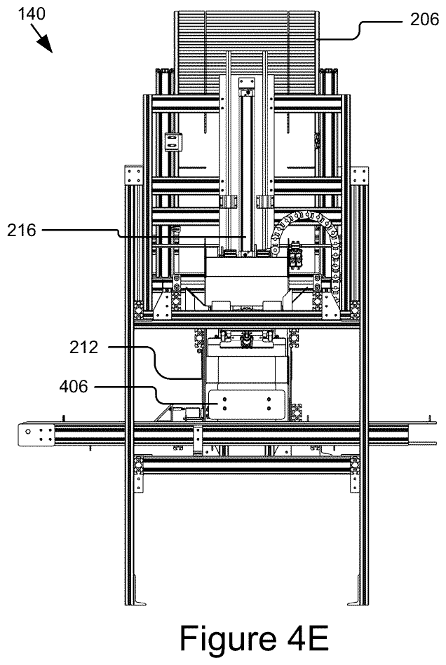

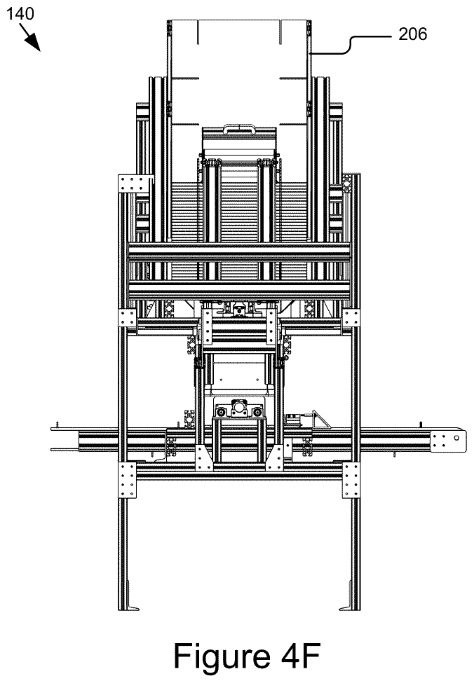

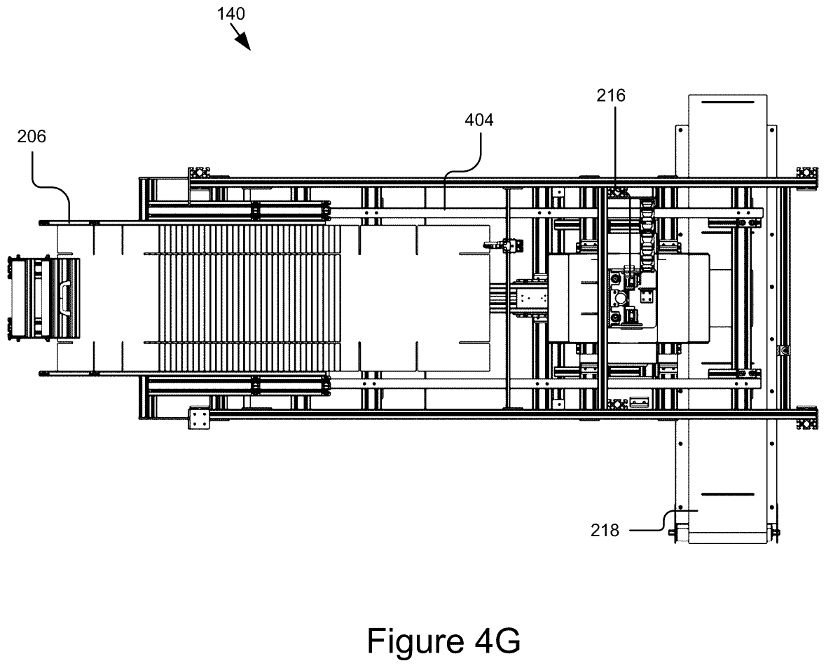

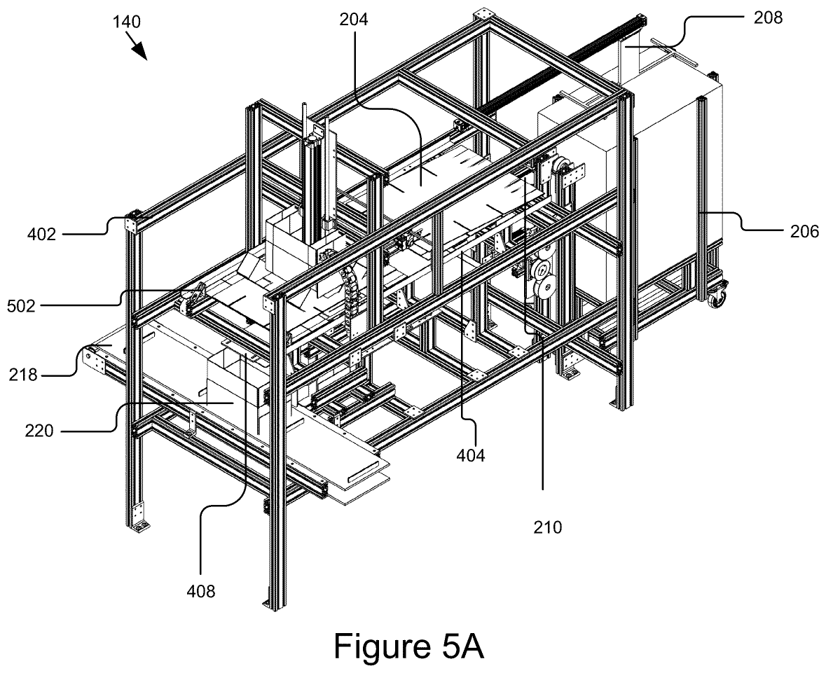

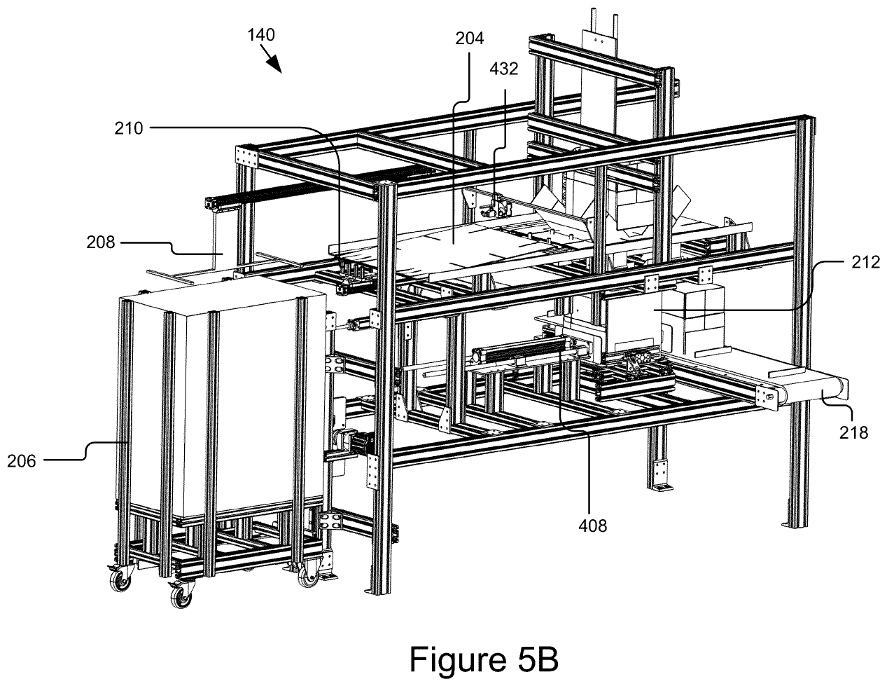

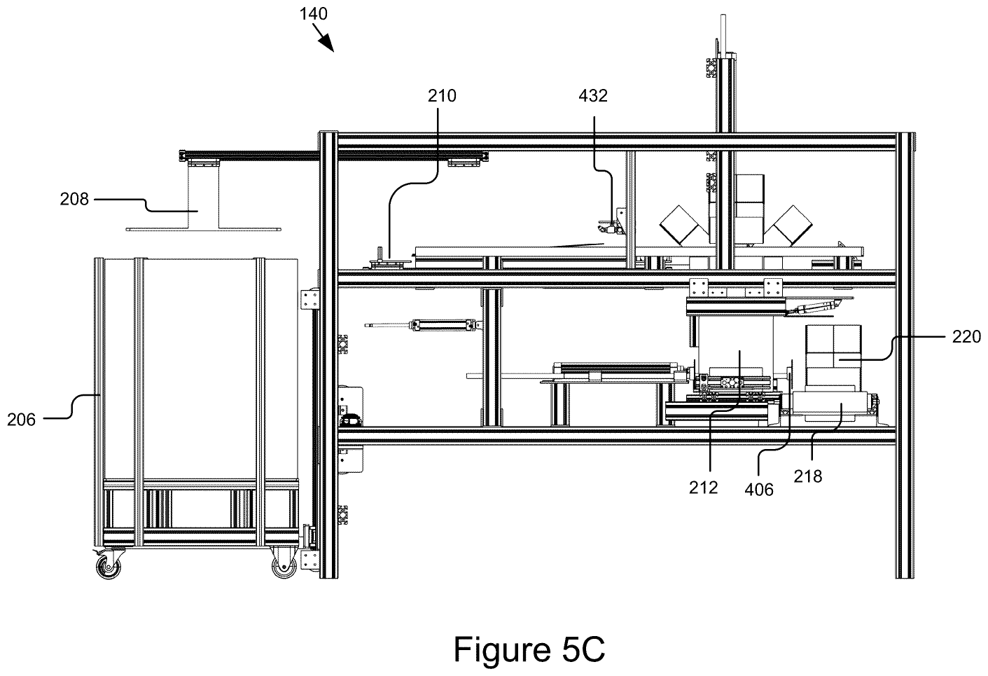

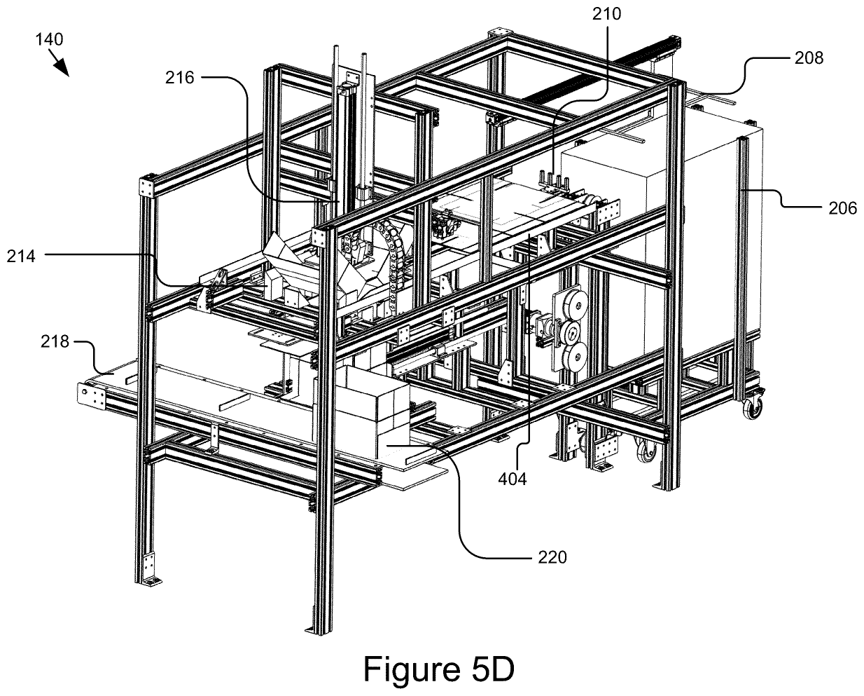

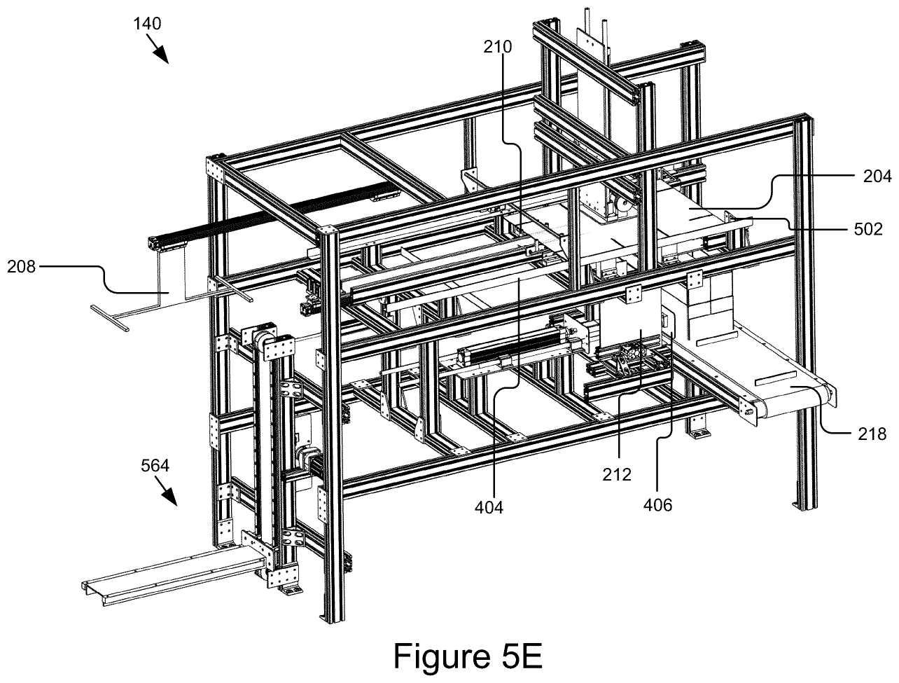

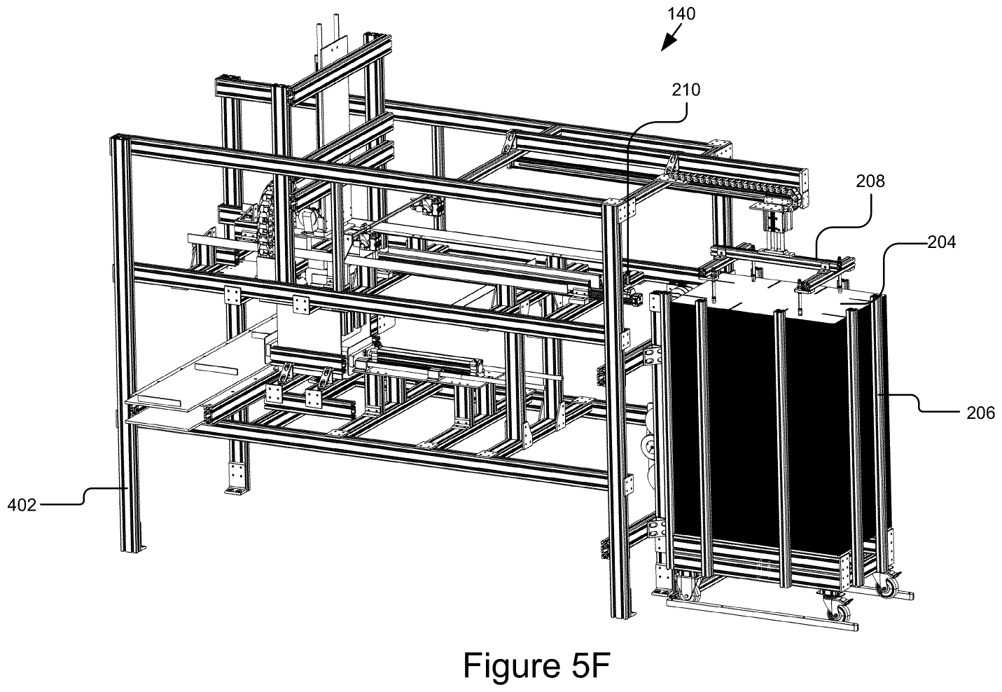

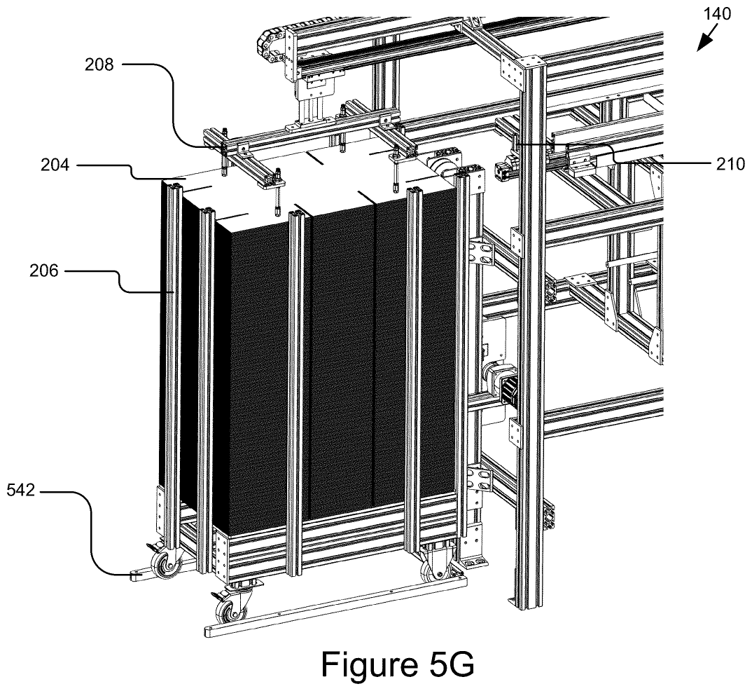

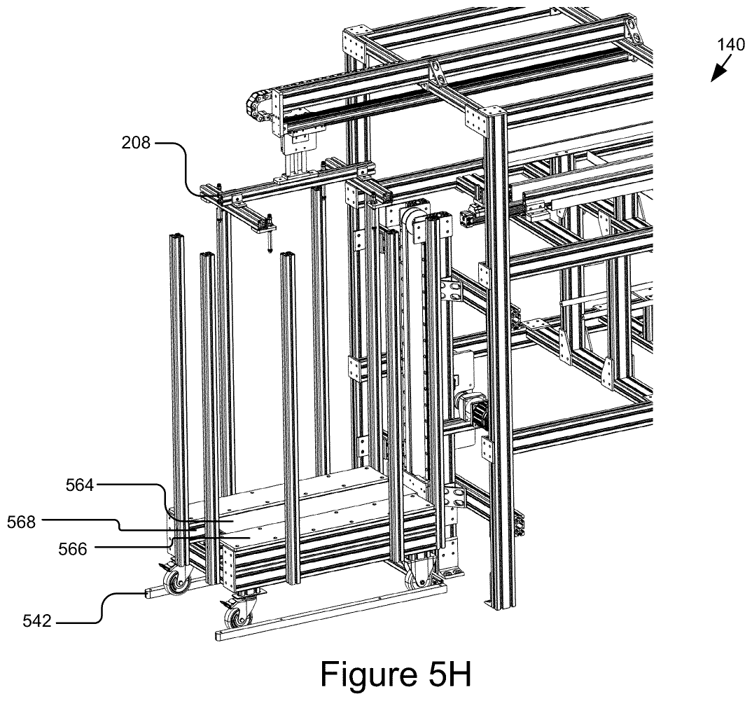

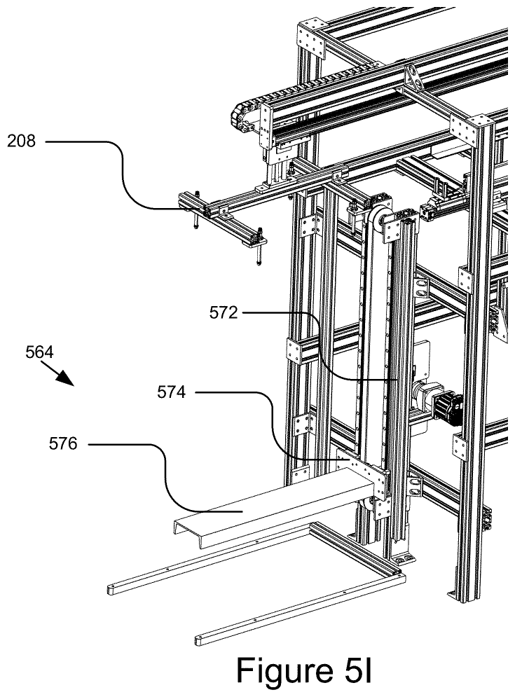

In the illustrated example, a box former 140 (e.g., illustrated at box former 140 A) may include a carton magazine 206 holding a plurality of carton blanks 204 (e.g., cardboard flats with die cut, scored, or stamped areas, as described below). The carton magazine 206 may be on a cart (e.g., as illustrated in the example of FIG. 5A), loaded from above (e.g., as illustrated in the example of FIG. 4A), or otherwise. For instance, a carton magazine 206 may hold materials for a particular size of box and the size may be identified at the box former 140, for example, based on a scan of a barcode, QR code, RFID tag, etc., by a sensor at the box former 140 or by a human interface device.

As illustrated in the box former 140a of FIG. 2A, a carton blank 204 may be held on a carton magazine 206 that is above, below, or otherwise adjacent to other components of the box former 140a, so that carton blanks 204 may be moved from the magazine and to other parts of the box former 140a.

For example, a carton dispensing device may be a device with various configurations that provides one or more carton blanks to the box former 140 or portions thereof. For instance, a carton dispensing device may include the various implementations of the magazine 206 described herein.

One or more carton blank moving devices may move a carton blank 204 between a carton blank dispensing device and an active location, such as between a plunger 216 and a forming well 212. Depending on the implementation a single device or multiple devices may transport or translate (e.g., horizontally) carton blanks 204. For example, as described below, the one or more carton blank moving devices may include a carton grabber 208 and/or a carton conveyance mechanism 210.

A carton grabber 208 may move items from the carton magazine 206 and onto a carton conveyance mechanism 210 or otherwise to a forming well 212. A carton conveyance mechanism 210 may slide a carton blank 204 horizontally to a forming well 212. Multiple mechanisms or a single mechanism may be used to perform these operations and various configurations are possible and contemplated herein. Examples are described below.

For instance, as shown in the box former 140b of FIG. 2A, a carton blank 206 (not labeled separately) is shown moved from a carton magazine 206 toward a forming well 212. For instance, a carton grabber 208 may move a carton blank 204 from the magazine 206 to a carton conveyance mechanism 210, and/or it may be removed from the magazine 206 by a carton conveyance mechanism 210 or another device. In some implementations, it may slide horizontally from a magazine 206 toward a forming well 212.

Depending on the implementation, a carton blank 204 may have a pre- applied adhesive (e.g., glue, tape, double sided tape, staples, etc.), or the adhesive may be applied as it is moved by the carton conveyance mechanism 210 (e.g., between a magazine 206 and a forming well 212), as described in further detail elsewhere herein.

The carton blank 204 may be positioned above the forming well 212 using the carton conveyance mechanism 210 and one or more adjustable bumpers and tracks. For instance, as shown in the carton former 140c, a carton blank 204 has been moved to a defined location (e.g., centered) above a forming well 212 and below a plunger assembly 216, for example, along one or more tracks and until it contacts one or more bumpers that have been positioned for the size and/or configuration of carton, as noted elsewhere herein.

An actuatable plunger assembly 216 may press the carton blank 204 through forming guides 214 that may cause one or more side walls of the box to fold as it is pushed into the forming well 212, which may be below the forming guides 214. As illustrated in the box former 140d, a carton blank 204 has been pushed through the forming guides 214 and into a forming well 212, which has caused the sides of the box to fold upwards in sequence and, it may have pressed them together to set the adhesive (or the sides may be taped as it is pressed downward or pushed out of the box former 140). Although the forming guides 214 are shown surround at least a portion of the opening of the forming well 212, they may be otherwise proximate or between the plunger 216 and the forming well 212.

In some implementations, once the sides of the box are folded in the forming well 212, they may be pressed or otherwise adhered together in order to set the adhesive and the box's shape. Additionally, in some instances, a label may be applied or scanned on the box.

Once the box is formed, it may be pushed out of the box former 140 and onto a conveyor 218 where formed boxes 220 are conveyed to other areas of the facility where they are needed. For example, as shown at box former 140e, a formed carton 220 may have been pushed out of the forming well and onto a conveyor 218. In box former 140e a magazine 206 is shown empty.

In some implementations, although only a single carton blank 204 is shown being processed at a time, multiple carton blanks 204 may be processed by a box former 140 simultaneously, for example, where a first carton blank 204 is grabbed by a carton grabber 208, a second carton blank 204 is moved by a carton conveyance mechanism 210, and a third carton blank 204 is being formed in a forming well 212 by a plunger assembly 216.

It should be noted that while certain movements, interactions, paths, locations, and devices are illustrated, other implementations are possible and contemplated herein. The examples of FIG. 2A are provided as illustrative examples.

FIG. 2B illustrates a perspective view of a pair of box formers 140 (or a box former may have parallel components to allow it to prepare multiple boxes) in which cardboard carton blanks 204 are loaded into a magazine 206 by a human agent, transferred to the box former 140, glued, formed by a forming plunger 216, and conveyed away from the box former 140. In the illustrated example, two box formers 140 are illustrated next to each other. For example, adjacent box formers 140 may share components, such as frames 402, supports, conveyors 218, or platforms.

In the depicted example, a magazine 206 may be a cardboard loading area in which carton blanks 204 are loaded into a box former 140, for example, where a human agent, humanoid robot, or AGV 114 lifts carton blanks 204 into the magazine 206. Additional, or alternative example details, implementations, and features are described elsewhere herein.

FIG. 2C illustrates a perspective view of a pair of box formers 140 in which the formed boxes 220 are sent downstream on the conveyors 218 to various sorting, picking, and packing equipment. In some implementations, once items have been picked into the formed cartons, they may be closed using tape or adhesives and using manual or automated methods. In the depicted example, an agent carries carton components, such as carton blanks 204, up a ramp or stairs to load them into a magazine 206. The box former(s) 140 may be set up for two sizes of cartons, each loaded separately. The box former(s) 140 may form boxes using the carton blanks 204 and push them out onto a carton conveyor 218.

As illustrated in the example of FIG. 2C, the conveyor 218 may carry formed carton(s) 220 past/to a picking area 252 at which items are picked into the carton(s) 220. In the depicted example, the picking area 252 includes a carousel of item staging or holding areas 254 into which items are picked by a robotic arm 256. For instance, an AGV 114, conveyor, or other device may transport totes 258 or other mobile storage units to a picking area 252, and a robotic arm 256 may pick items from the totes 258 into the item holding area(s) 254. Once one, multiple, or all items for an order or pick task are in an item holding area 254, it may be dumped, pushed, or otherwise have the items moved into a particular carton 220.

The conveyor 218 or another conveyor may convey the carton(s) 220 (potentially filled with items) away from the picking area 252 for further processing. In some instances, if the carton 220 is complete, it may have shipping labels applied, packing slips or other documents inserted, and the carton closed, which steps may be performed automatically or by a human agent, for instance.

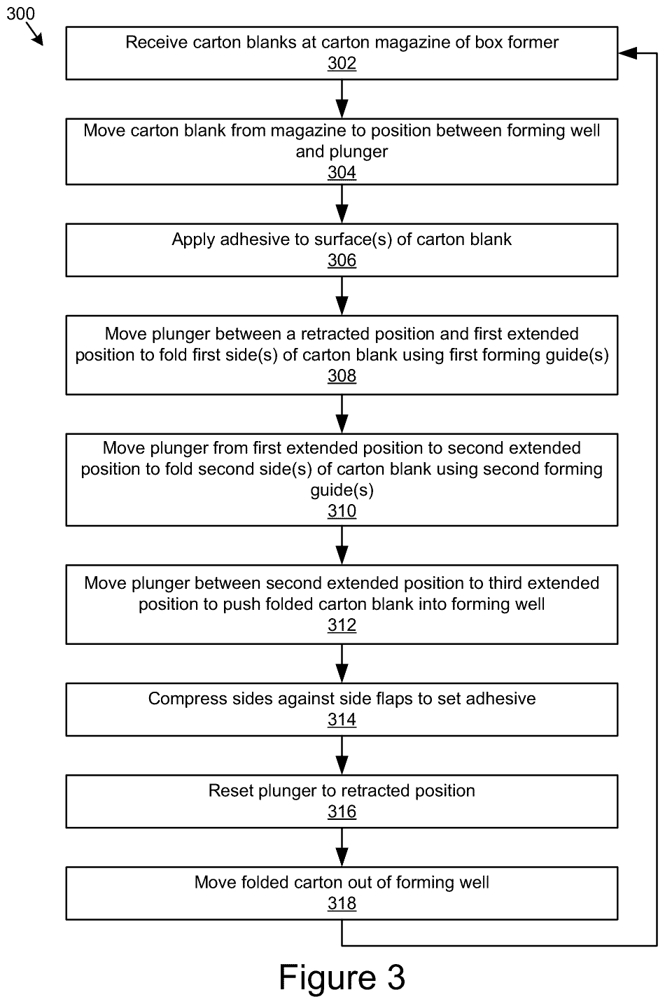

FIG. 3 is a flowchart of an example method 300 for forming cartons or boxes using carton blanks 204 or other sheets of material. The operations described in reference to FIG. 3 may be used with components and features described throughout this description. It should be noted that the operations of the method 300 may be used interchangeably or with the other operations and features used herein. Furthermore, it should be noted that operations of the method 300 and of this description may be augmented, reordered, omitted, or modified while still using technologies described in this disclosure. It should be noted that, although the operations of the method 300 are described as being performed by the box former 140, it may be controlled by an equipment controller 110, other implementations are possible. The equipment controller 110 may be coupled with various sensors, motors, actuators, and devices, such as those described throughout this disclosure. For instance, they may be controlled by a WES, human agent, or other device, such as those of the system 100.

The operations and features described in reference to FIG. 3, for example, may be described in additional detail throughout this disclosure, both in terms of the operations and mechanical components.

At 302, the box former 140 may receive a plurality of carton blanks 204 at a carton magazine 206 of a box former 140. For instance, a new set of carton blanks 204 may be loaded or a new magazine 206 holding carton blanks 204 may be loaded. In some implementations, using a coupled sensor, the equipment controller 110 may detect the carton blanks 204, quantity of carton blanks 204, magazine 206 (e.g., a cart magazine 206), or otherwise (e.g., using a sensor or input device). The equipment controller 110 may detect a low number of carton blanks 204, transmit an instruction to a human interface device 108 requesting a refill, detect the refill, and/or perform other operations. In some instances, the sensor(s) may automatically detect a size, shape or otherwise of the carton blanks 204 or magazine 206, for example, to ensure that it is loaded in the right box former 140 or to cause it to be placed in the right box former 140.

A carton blank 204, as noted elsewhere herein may include a plurality of folding points at which the carton blank 204 may be folded to create a folded carton.

At 304, the box former 140 may move a carton blank 204 of the plurality of carton blanks 204 from the carton magazine 206 to a position between a forming well 212 and a plunger 216. The position may be defined by a center of the carton blank 204 being below a bottom plate of a plunger 216 of the box former 140, which may be above the forming well 212 when the box former 140 is in an in-use position, as shown in the example of FIG. 5E.

In some implementations, the movement of the carton blank 204 to the defined position may be performed in two steps, such as by using a carton grabber 208 and a carton moving mechanism 210, as noted elsewhere herein. The position may be defined using adjustable side rails/carton tracks and/or end stops, sensors, or other devices, as described elsewhere herein.

Moving the carton blank 204 may be performed as described using the operations and/or components described herein. For instance, the equipment controller 110 may receive a request for the box size corresponding to the carton blanks 204 in a particular magazine 206. The equipment controller 110 may automatically actuate the motors, pneumatic actuators, or other equipment to move the carton blank 204.

At 306, the box former 140 may apply adhesive to one or more surfaces of the carton blank 204. For example, as the carton blank 204 moves (e.g., during movement) from the magazine 206 to the forming well 212, the box former 140 may spray, roll, or otherwise apply adhesive onto areas of the carton blank's surface that will be between layers of material (e.g., cardboard). As also noted elsewhere herein, adhesive, tape, fasteners, etc., may additionally or alternatively be applied in the forming well 212, as the formed box 220 leaves the well, or otherwise. In some implementations, a sensor coupled with an adhesive applicator 432 may detect the correct portions of the carton blank 204 and automatically apply adhesive onto these portions.

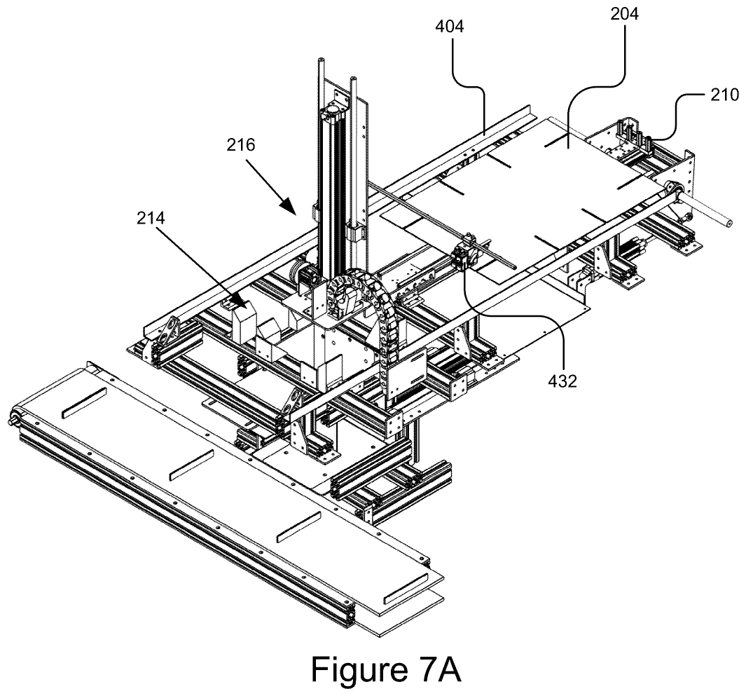

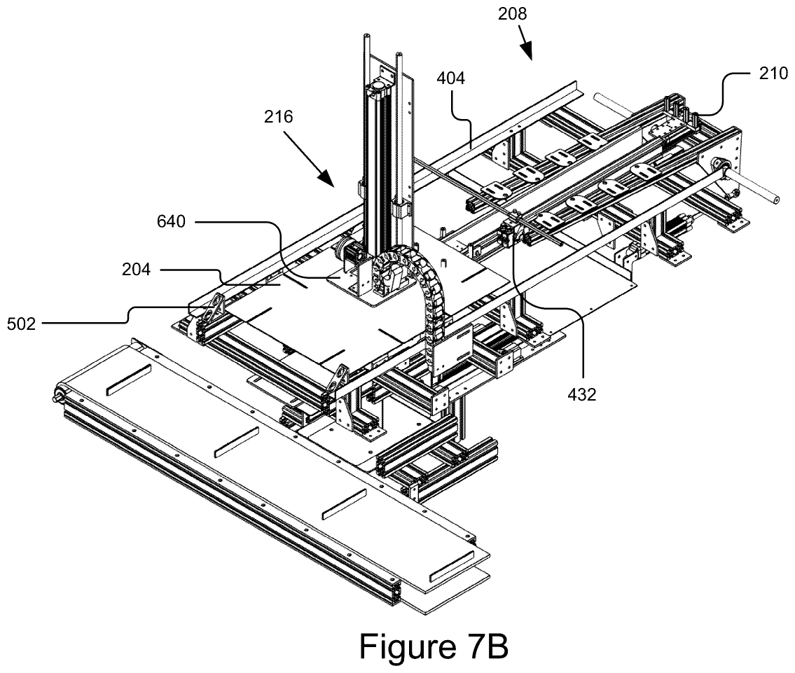

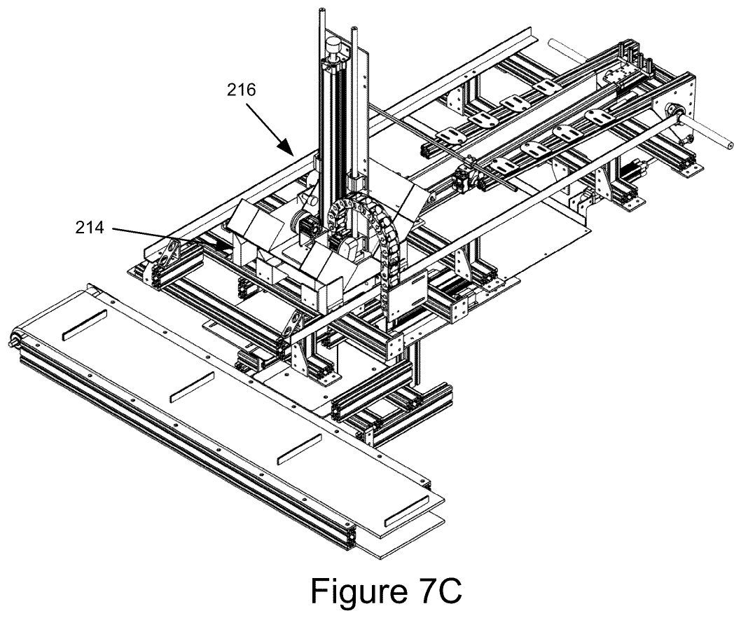

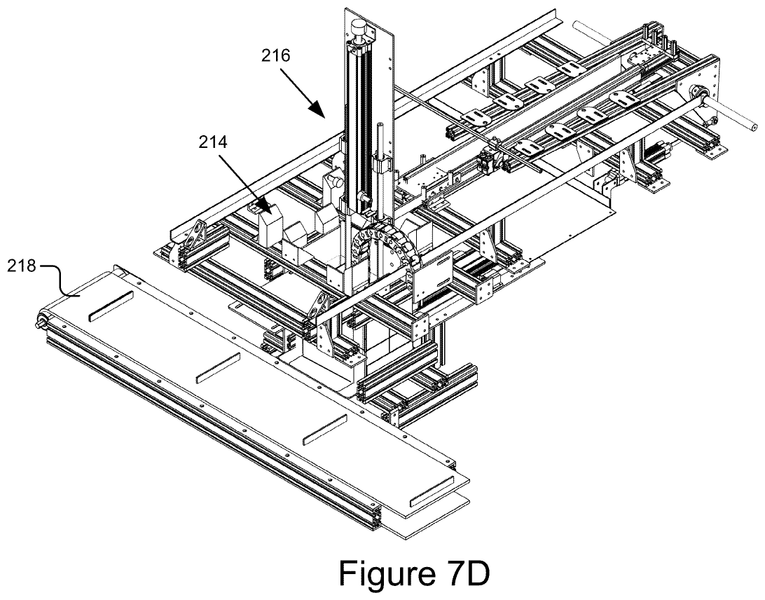

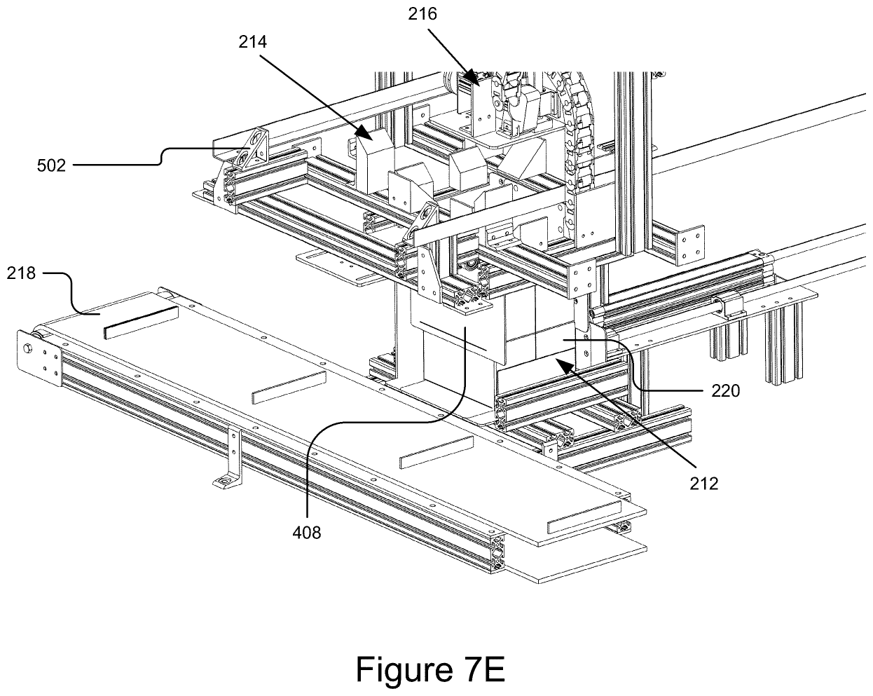

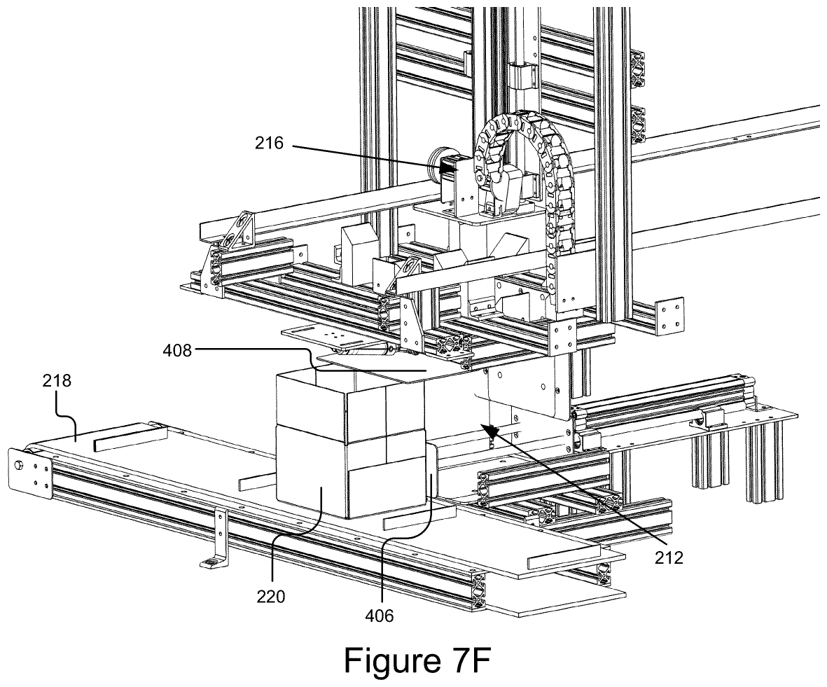

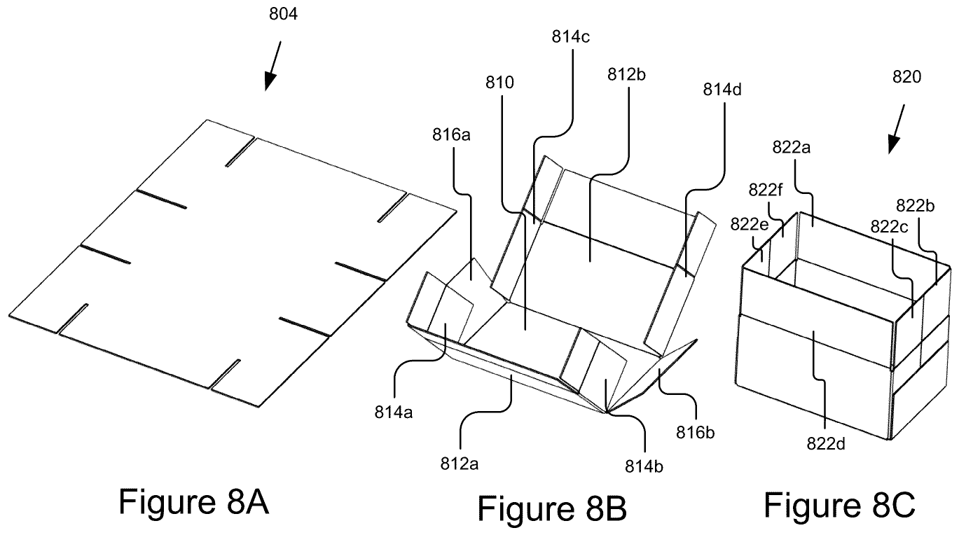

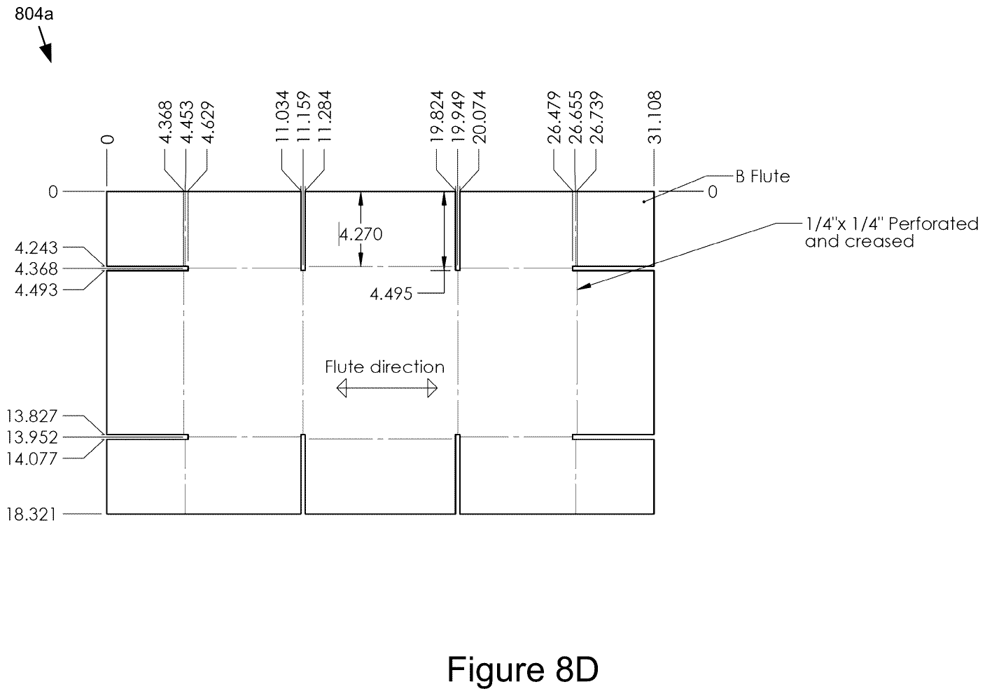

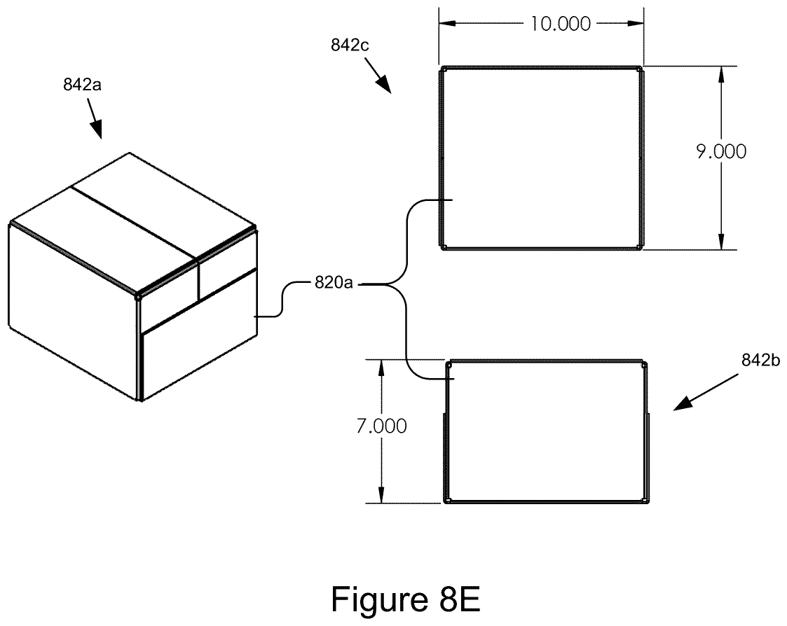

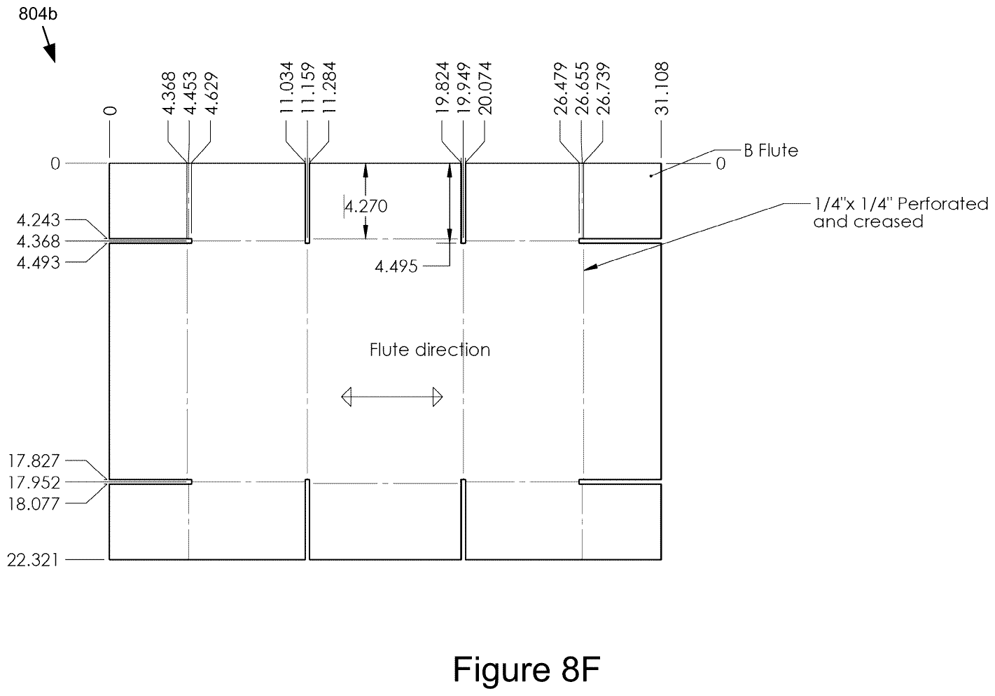

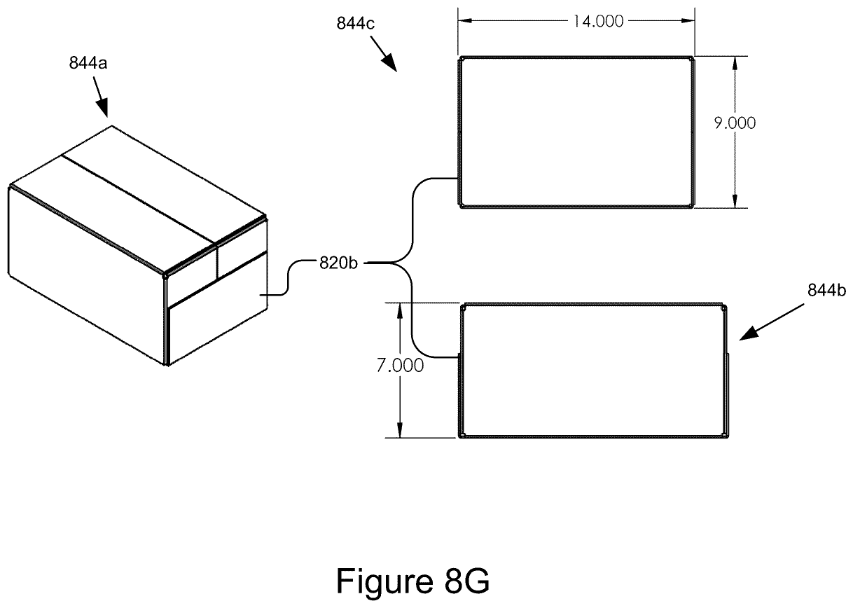

At 308, 310, and 312, the box former 140 may fold the carton blank 204 into the folded carton by moving the plunger between a retracted position and an extended position (e.g., vertically downward into the forming well 212). In some implementations, moving the plunger may include causing various points on the carton blank 204 to sequentially contact multiple different forming guides 214. The equipment controller 110 may automatically extend the plunger when the carton blank 204 is at the defined position and a forming well 212 is ready (e.g., empty and closed) to receive the carton blank 204. These operations are shown and illustrated elsewhere herein, such as in reference to FIGS. 7A-8C.

In some implementations, at 308, the box former 140 may move the plunger 216 between a retracted position and a first extended position to fold one or more first sides of the carton blank 204 using a first set of forming guides. For example, the box former 140 may push, by the plunger 216 against a top surface of the carton blank 204 until a first forming guide 214 contacts a first point on a bottom surface of the carton blank 204. The first forming guide 214 pushing against the first point may cause one or more portions (e.g., side flaps) of the carton blank 204 to start folding upwards.

In some implementations, at 310, the box former 140 may move the plunger from the first extended position to a second extended position to fold one or more second sides of the carton blank 204 using a second set of forming guides. For example, the box former 140 may push, by the plunger 216, the top surface of the carton blank 204 until a second forming guide 214 contacts a second point on the bottom surface of the carton blank 204. The second forming guide 214 pushing against the second point may cause one or more second portions (e.g., one or more of a front and a back) of the carton blank 204 to fold upwards.

Various quantities or types of forming guides, folds, or other structures may be used. For example, in some implementations, the box former 140 may push, by the plunger, the top surface of the carton blank 204 until a third forming guide 214 contacts a third point on the bottom surface of the carton blank 204. The third forming guide 214 pushing against the third point may cause one or more third portions (e.g., one or more sides) of the carton blank 204 to fold upwards. For example, the one or more sides of the carton blank 204 may contact the one or more side flaps when folded, as illustrated in FIGS. 8A-8C. The contact point between the sides and side flaps may correspond to the surfaces to which the adhesive was applied.

In some implementations, at 312, the box former 140 may move the plunger 216 from the second or third extended position to a third or final extended position to push the folded carton blank into a forming well 212. For instance, the forming well 212 may be adjustable so that it is sized and shaped based on the size of the formed box. By pushing the carton blank 204/formed box completely into the forming well, the sides may be completely folded, for example, at a 90-degree angle to their original configuration in the blank.

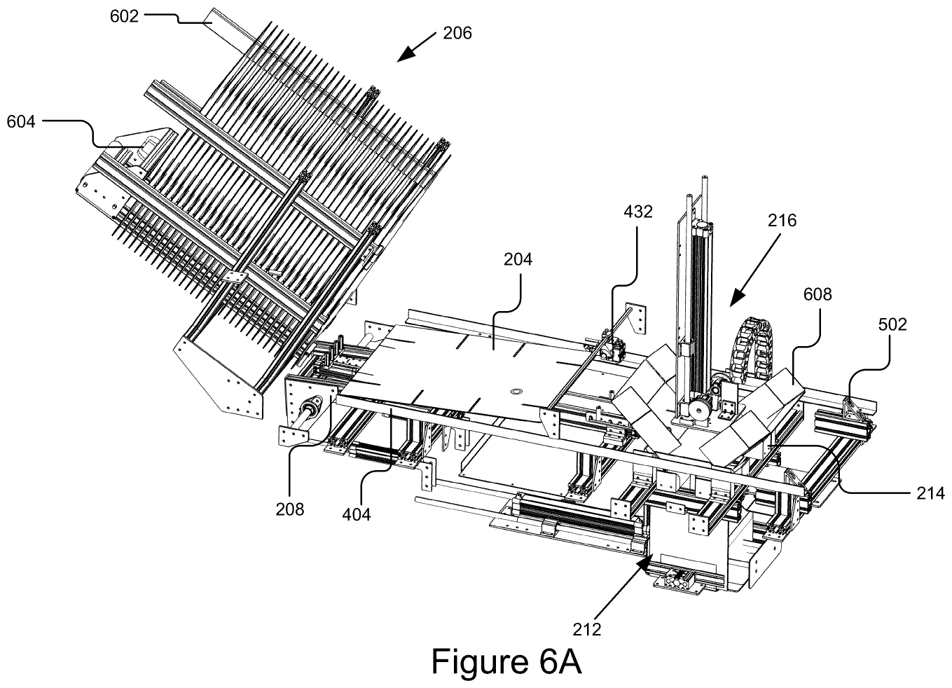

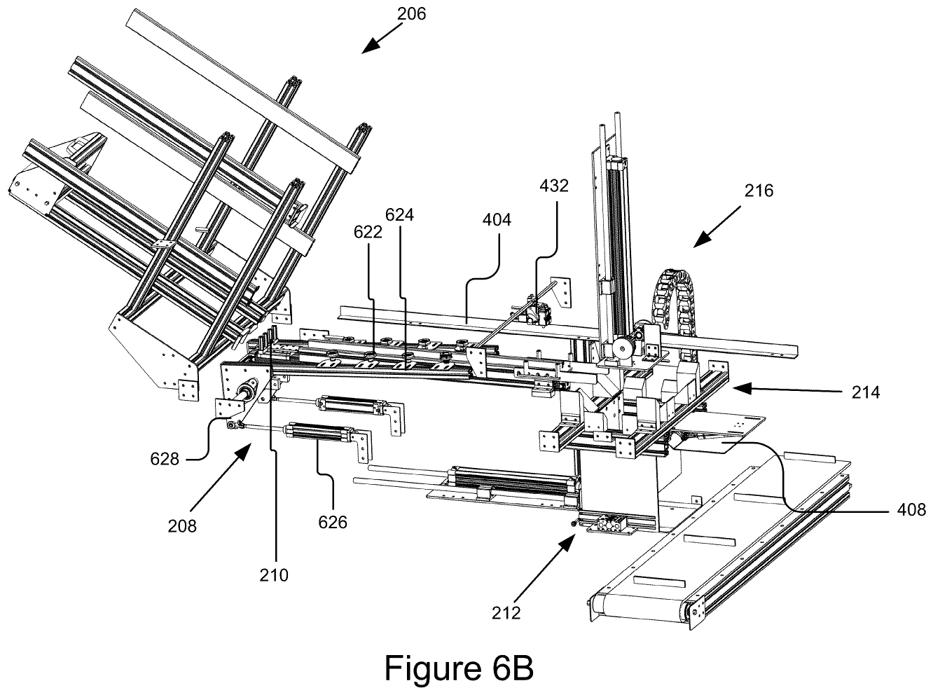

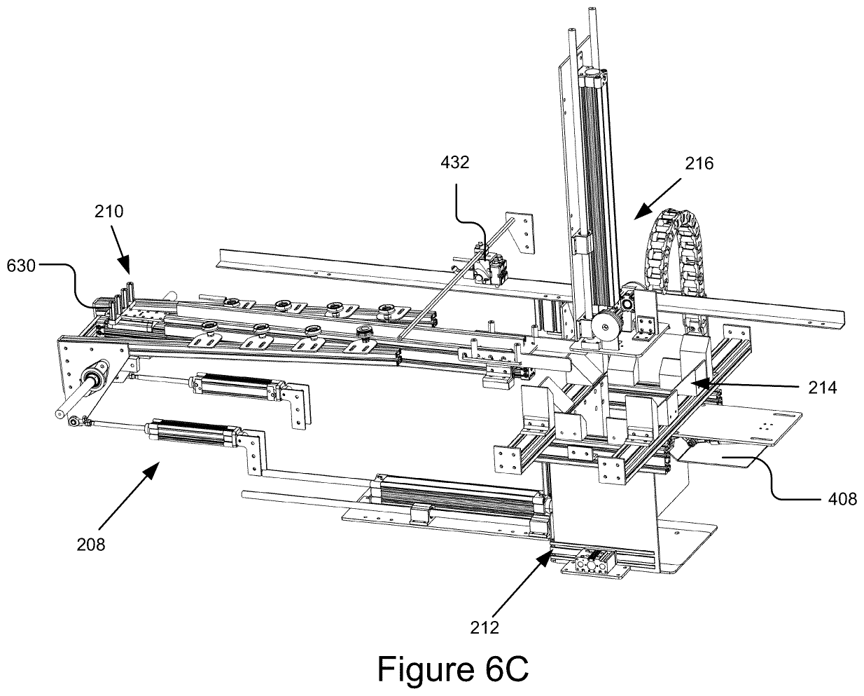

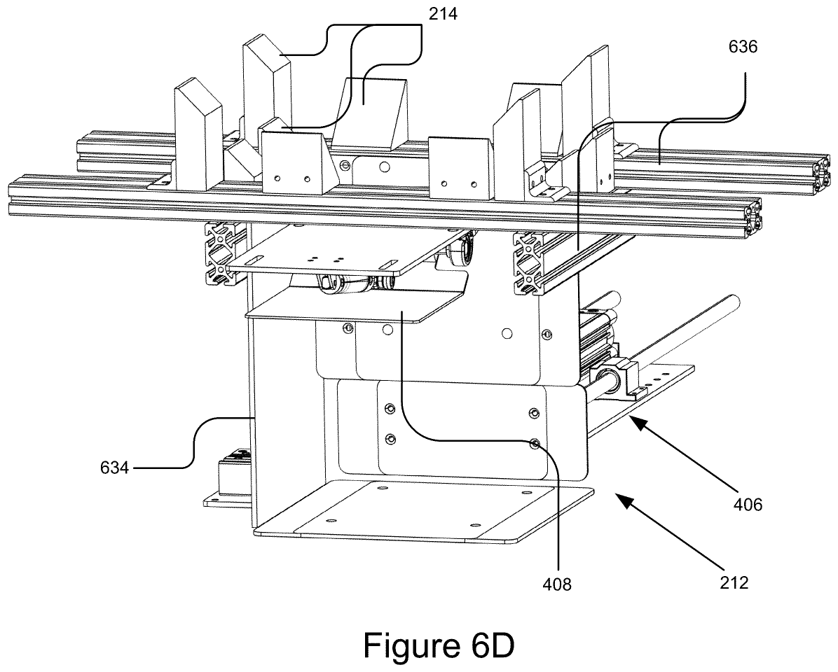

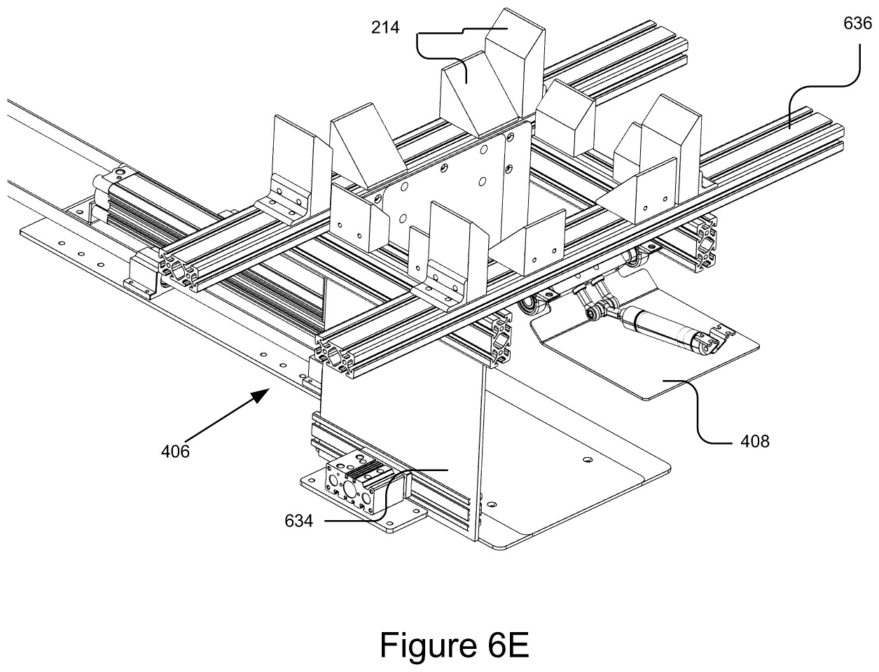

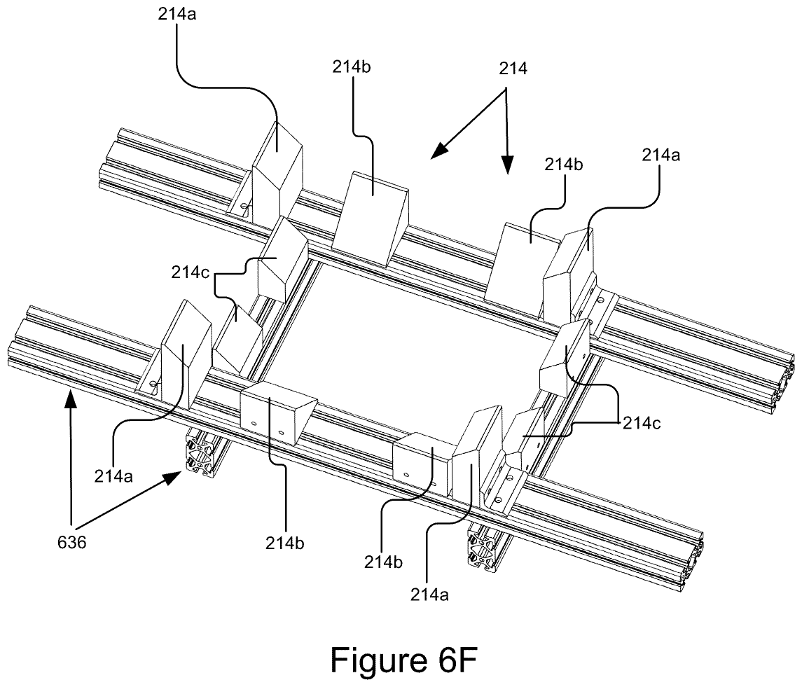

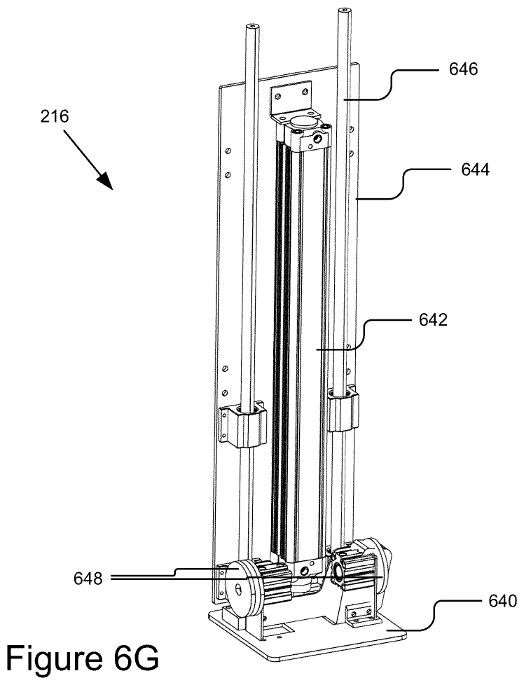

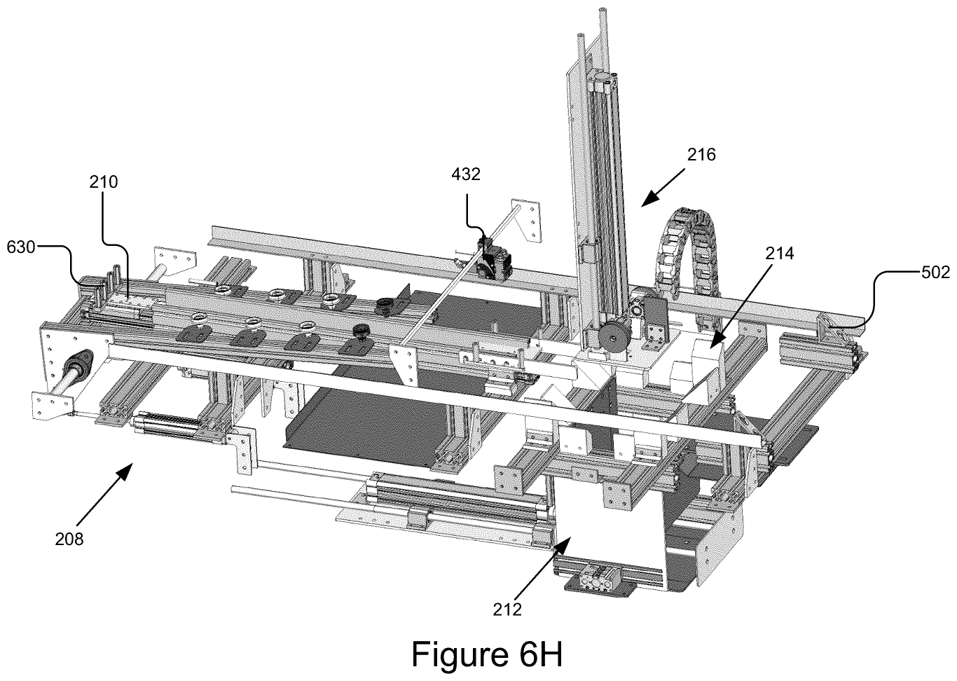

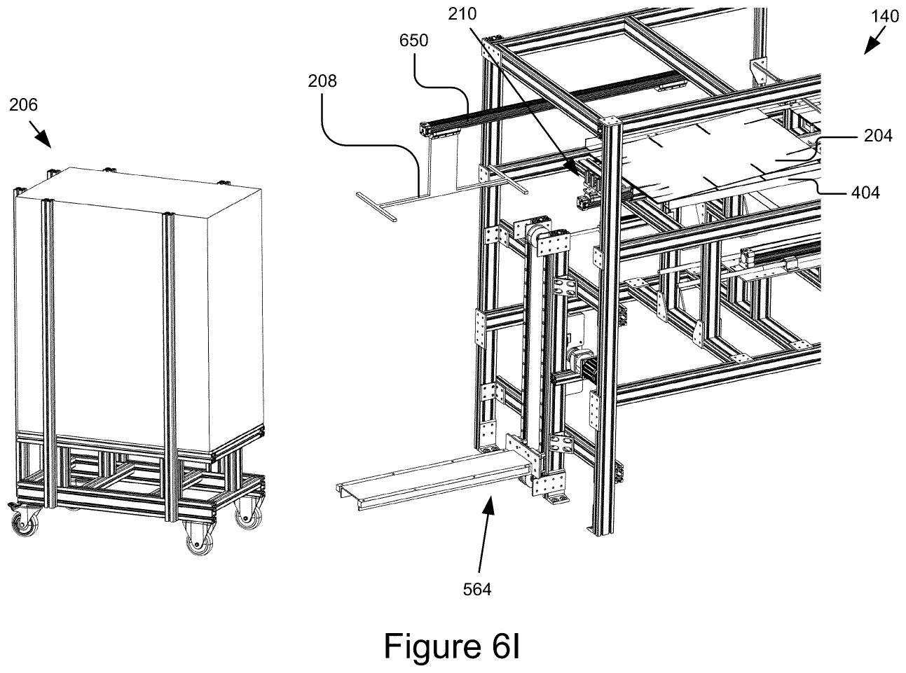

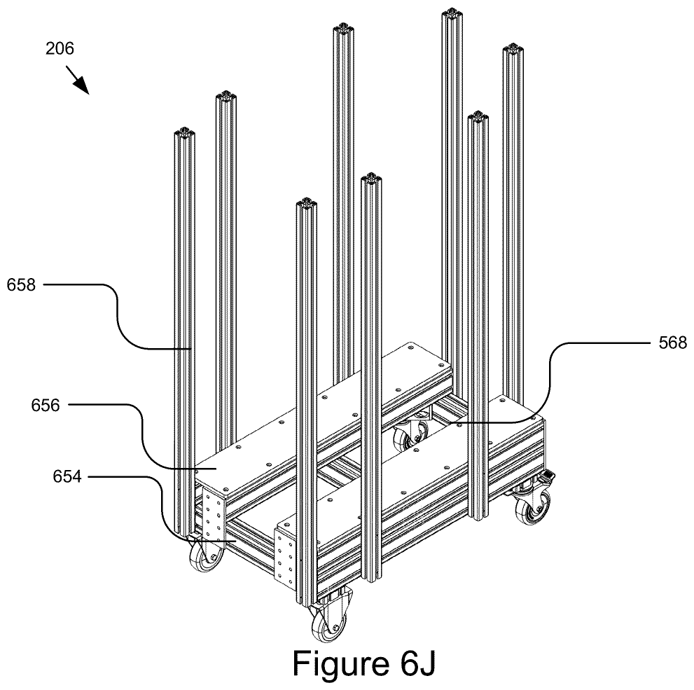

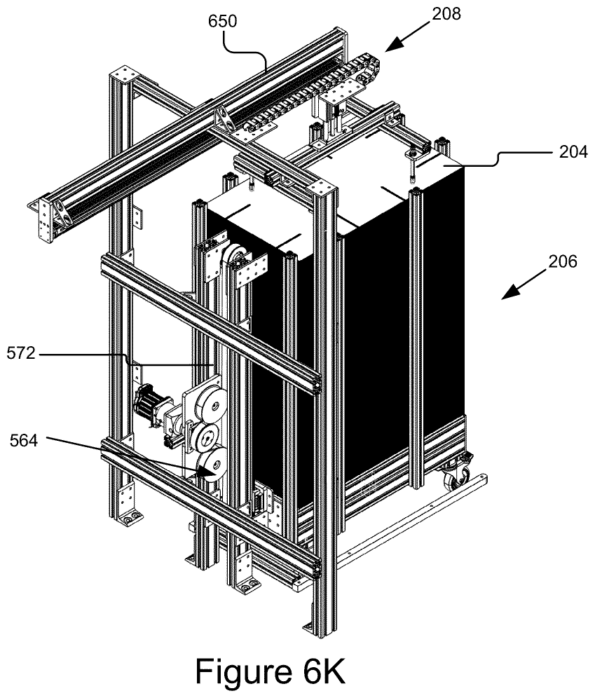

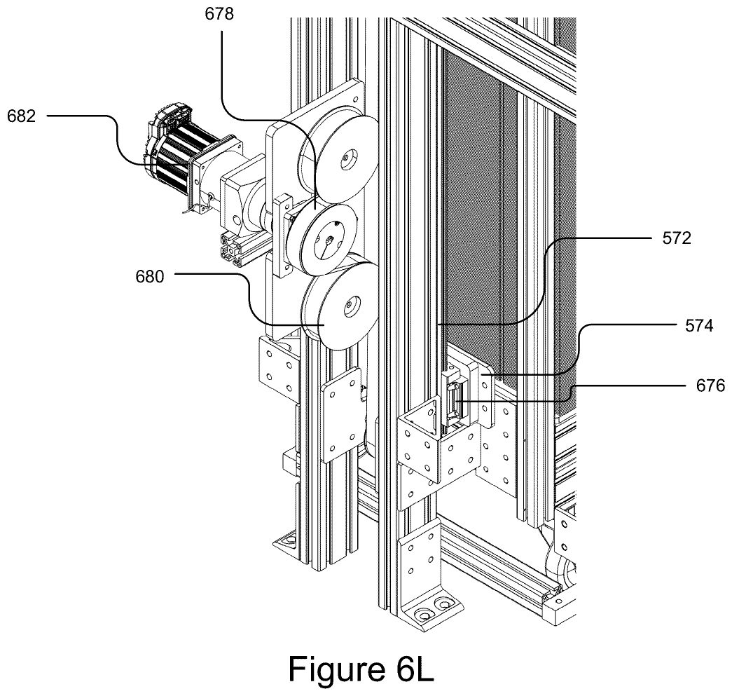

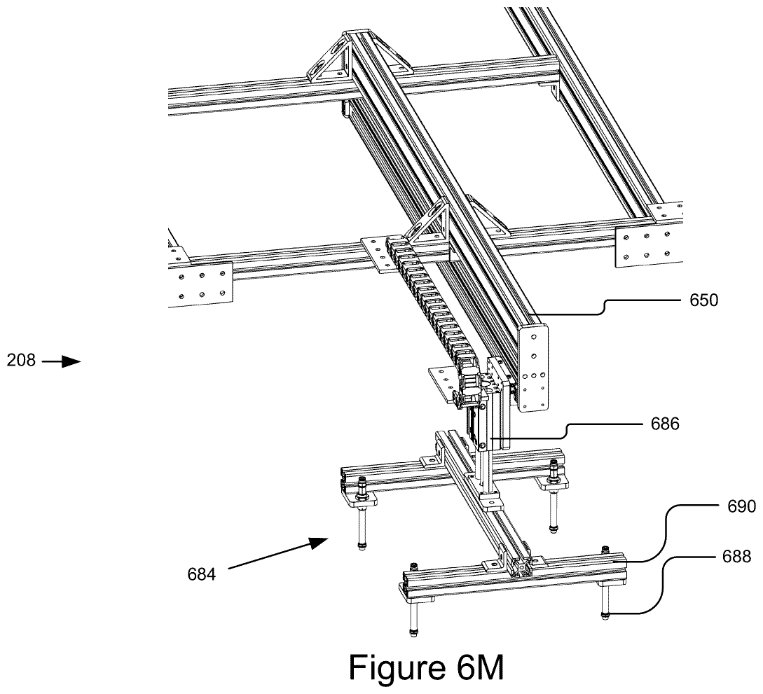

At 314, the box former 140 may compress the one or more sides against the one or more side flaps to set the adhesive. For example, once the plunger has completely pressed the carton blank 204 into the forming well 212 (e.g., where the carton blanks 204 bottom surface contacts a floor of the forming well 212), the side walls may be compressed to improve adherence of the adhesive. As described elsewhere herein, side pushers (e.g., 406 in FIG. 6D and/or 648 in FIG. 6G), movable side walls (e.g., of the forming well 212), and/or other components may be actuated (e.g., by the equipment controller 110, a sensor, etc.) to push the side flaps and sides together. This process may improve adhesion and form the flaps and sides (and front/back) of the carton blank 204 into walls of the carton/box. For example, using side pushers 406 on the plunger assembly 216 that is slightly narrower than a bottom of the box and then extending the side pushers 648 outward may reduce warping of the box.

In some implementations, the box former 140 may heat the adhesive to set it, apply fasteners (e.g., staples), apply tape (e.g., using a tape applicator that moves or applies tape as the carton moves into the forming well), or otherwise fasten the walls/flaps of the carton together.

In some implementations, at 316, the box former may reset the plunger 216 to the retracted position. For instance, the side pushers 648 may be retracted then the plunger 216 may be retracted out of the formed box 220, leaving the formed box 220 in the forming well 212.

At 318, the box former 140 may move the folded carton 220 out of the forming well 212. For example, the equipment controller 110 may open a forming well door (e.g., a side wall 408 of the forming well 212) by actuating a pneumatic cylinder and/or moving a motor. The equipment controller 110 may actuate a pusher 406, belt, diverter, or various other mechanisms to push the formed carton out of the forming well 212. Other methods of removing the carton (e.g., pushing it upwards/outwards of the forming well 212) may additionally or alternatively be used. For example, the pusher 406 may push the formed box 220 out of the forming well 212, through a side opened by opening a well door 408, and onto a conveyor 218 belt, upward through the top of the forming well 212, or downward through an openable floor of the forming well 212.

The process may repeat automatically for a next box being formed based on a received signal or trigger (e.g., when a box of the corresponding size is needed), automatically until a certain quantity of boxes are formed, until there are no more carton blanks 204 left in the magazine 206, when there is available space on a conveyor 218, or otherwise. Some operations of the method 300 may be performed simultaneously with the same or separate carton blanks 204, for example, while a first carton blank is being pushed into a forming well 212, a second carton blank may be removed from a magazine 206.

In some implementations, the box former 140 may include a sensor that indicates when there are no or fewer than a defined quantity of carton blanks 204 remaining in the magazine 206. An equipment controller 110 may transmit a notification to a WES 102, WMS 104, REX 118, human interface system 108, or other device requesting that the magazine 206 be replaced or refilled, as noted elsewhere herein.

It should be noted that some or all of the operations may be performed automatically by an equipment controller 110. In some implementations, some or all of the operations may be controlled by a human user, such as by applying physical force via levers, by pressing buttons, or otherwise.

FIGS. 4A-4G illustrate example implementations of a box former 140 with an example top-loading magazine 206. For example, FIG. 4A illustrates a left perspective view of an example box former 140, FIG. 4B illustrates a right perspective view of an example box former 140, FIG. 4C illustrates a left-side view of an example box former 140, FIG. 4D illustrates a right-side view of an example box former 140, FIG. 4E illustrates a front view of an example box former 140, FIG. 4F illustrates a back view of an example box former 140, and FIG. 4G illustrates a top-down view of an example box former 140. Although other configurations are possible, an example configuration is illustrated. The features described in reference to the various figures herein may be omitted, changed, interchanged, or augmented without departing from the technology. For instance, aspects of some example implementations may be used with other implementations.

Example components of the illustrated box former 140 may be described in further detail in reference to other figures, although various configurations are possible.

As illustrated, the box former 140 may be generally rectangular and its components linearly arranged where carton blanks 204 move linearly from a carton magazine 206, through to a conveyor 218 on an opposing end, although right angle or other configurations are possible and contemplated. For example, a carton grabber 208 assembly (as described in further detail below) may hinge upward to grab (e.g., using pneumatic suction) a carton blank 204 from the magazine 206 and downward to place it on the carton track 404 and/or carton conveyance mechanism 210. The carton conveyance mechanism 210 may push the carton blank 204 along the carton track 404 until it is stopped by the carton positioning bumper 410. The carton conveyance mechanism 210 and positioning bumper 410 may be adjusted to fit various sizes or configurations of carton blanks 204 in order to properly position them above the forming well 212 and/or below the plunger assembly 216. It should be noted that, in some implementations, these components may be oriented vertically or horizontally without departing from the technologies described herein.

In some implementations, as the carton blank 204 is moved by the carton conveyance mechanism 210, adhesive may be applied using an adhesive applicator 432. For instance, one or more adhesive applicator(s) 432 (only one is illustrated but other quantities are possible) may spray, squirt, roll, brush, or otherwise apply adhesive to adhesion/contact points of the carton blank 204, so that they remain adhered when the box is formed. In other implementations, the box former 140 may include a one-or two-sided tape applicator, for example, in or at the exit of the forming well 212 to apply tape to the box, such as to one or more seems of the folded box.

Once the carton blank 204 is positioned correctly, the plunger assembly 216 may move downward to push it through the forming guides 214. As described in further detail below, the forming guides 214 may include an adjustable frame 402 and ramps with different positions and/or heights. As the carton blank 204 is pushed by the plunger 216, different guides 214 contact various points of the carton blank 204 at different heights (e.g., as the plunger 216 is at different heights). Accordingly, the sides of the box/carton 204/220 may be folded in sequence in a single motion as the plunger 216 pushes the carton blank 204 through the forming guides 214 and into the forming well 212.

As described in further detail elsewhere herein, a front and/or back of the carton blank 204 may be folded upward first and the side(s) may be folded upward afterwards. For example, adhesive may be applied to the sides, which adhere to the folded front/back. Additional details of the carton blank 204/carton 220 are described in further detail below.

In some implementations, once the plunger assembly 216 has pushed the carton fully into the forming well 212, so that the sides of the box are vertical, pressure may be applied to the sides to ensure that they stick together using applied adhesive. For example, as described in further detail below, pneumatic, hydraulic, mechanical, or electronically actuated components on the pusher 406 assembly may push the carton sides outward against the side(s) of the forming well 212 to compress the adhesive. Additionally, or alternatively, side walls of the forming well 212 may be sprung or flexible and/or may use pneumatic, hydraulic, mechanical, or electrically actuated plates to push inward.

In some implementations, once the sides of the carton 204/220 are adhered, the plunger assembly 216 may retract and a well door 408 forming a front side of the box former 140 may pivot or retract upwards. A pusher 406, as described in further detail below, may push the box/carton out of the forming well 212, for example, onto a conveyor 218.

As illustrated, a carton blank 204 may move from the magazine 206 through to the plunger assembly 216, downward into the forming well 212, and then out of the forming well 212 on to a conveyor 218. Various mechanisms for processing the carton blank 204 into a carton/box 220 are illustrated and described. These mechanisms may be automatically controlled by an equipment controller 110, which receives and/or sends instructions to various components to retrieve a carton blank 204, apply adhesive, move the carton blank 204 to the plunger assembly 216, extend the plunger assembly 216, compress the sides of the carton blank 204 together, open the forming well 212, move a formed box 220 out of the forming well 212, and convey it away from the box former 140 (e.g., on a conveyor 218); although other operations may be performed.

Various sensors, motors, actuators, and other devices may be automatically controlled by the equipment controller 110 to automatically perform these or other operations, as described elsewhere herein. For example, a first actuator (electrical, hydraulic, pneumatic, mechanical, etc.) may move a carton grabber 208 to a carton at which one or more suction cups or other devices grab a carton blank 204 and the actuator may move the carton blank 204 from a magazine 206. This action may be confirmed using a sensor, such as an optical beam break sensor or otherwise. A second actuator may move a carton conveyance mechanism 210 to push the carton blank 204 to a defined position above a forming well 212. The defined position may be based on or confirmed by the carton conveyance mechanism 210 or carton blank hitting a bumper, a sensor, or otherwise. When the carton blank 204 is determined to be at the correct location, a third actuator may cause the plunger 216 to push the carton blank into the forming well 212. The system may determine when the plunger 216 is fully extended and/or confirm using a sensor and it may extend side pushers 406 (mechanically, hydraulically, pneumatically, electrically, etc.) that push outward (and/or inward) to compress the sides of the box. The system may then retract the side pushers 406 and/or plunger 216, and then actuate another actuator to cause the door 408 to lift or otherwise move. Finally, an actuator of a pusher 406 may be actuated to push the formed box 220 out of the forming well 212 and onto a conveyor 218 or other device or place. In some cases, a database of locations or status, a sensor, or otherwise may detect that there is an available place (on a conveyor 218, AGV 114, chute, etc.) to which to push the formed carton 220 prior to the pusher 406 pushing it out/onto the available place. The pusher 406 may then retract and the door 408 may close to reset the box former 140.

It should be noted that these sensors and actuators are provided by way of example and that various implementations may be used without departing from the scope of this disclosure. For example, various types of actuators may be used, such as hydraulic or hydraulic pistons, linear motors, rotational motors, mechanical levers, or other types. In some implementations, various actuators, sensors, and controls may be coupled with a computing device at, near, or remote from the box former 140, such as an equipment controller 110 or coupled thereto.

It should be noted that some or all of these operations may be controlled by a human agent (e.g., pressing a button or physically moving components) without departing from the scope of this disclosure.

Additionally, it should be noted that various mechanical components may be moved by human force, gravity, pneumatics, hydraulics, or electrical motor(s).

FIGS. 5A-51 illustrate example implementations of a box former 140 with an example side-loading magazine 206. For example, FIG. 5A illustrates a right perspective view of an example box former 140, FIG. 5B illustrates a left perspective view of an example box former 140, FIG. 5C illustrates a left-side view of an example box former 140, FIG. 5D illustrates a right perspective view of an example box former 140 with an example formed box 220 moved on an example conveyor 218, and FIG. 5E illustrates a left perspective view of an example box former 140 with an example cart magazine 206 removed. Further details of the components of the example implementations shown in these figures are described in further detail elsewhere herein.

Although other configurations are possible, illustrated example configurations are provided. The features described in reference to the various figures herein may be omitted, changed, interchanged, or augmented without departing from the technology. For instance, aspects of some example implementations may be used with other implementations.

For example, in these figures, the carton magazine 206 may be mounted on or integrated into a cart, so that a stack of carton blanks 204 may be rolled, instead of lifted, by a human or AGV 114 to the box former 140. For example, when it is determined that a cart magazine 206 is empty or becoming empty, the equipment controller 110 or WES 102 (e.g., via a human interface device 108) may request that a user load and/or retrieve a cart having a defined size/configuration of carton blanks 204. The cart may be rolled onto a lifting mechanism 564, which lifts the cart and/or carton blanks 204, so that the carton blanks 204 may be moved (e.g., by a carton crabber assembly 208) into the box former 140. Although a similar carton grabber assembly 208 as is used by in the system of FIG. 4A may be used (e.g., by increasing the range of moment that it pivots), other mechanisms, such as an overhead mechanism that pulls carton blanks 204 from the carton may be used, for example, as illustrated in FIG. 5A. These and other configurations and components are described in further detail below.

As illustrated in FIG. 5E, a cart magazine 206 may be removable from the box former 140. For instance, in order to reload it, a cart may be rolled onto a lift mechanism 564 that lifts the carton blanks 204 and/or cart upwards, so that they are more easily handled by a carton grabber 208 mechanism that pushes the carton blanks 204 from overhead onto a carton track 404 and/or carton blank moving mechanism 210. These components are described in further detail elsewhere herein.

FIG. 5F is a right perspective view of another example implementation of an example box former 140 with an example cart magazine 206, FIG. 5G is a left perspective view of an example cart magazine 206 at a box former 140, FIG. 5H is a left perspective view of an example cart magazine 206 at a box former 140 with all carton blanks 204 removed, and FIG. 5I is a left perspective view of an example lifter 564 (e.g., a cart, magazine, or carton blank lifter) and an example carton grabber 208 assembly of a box former 140.

FIG. 5F illustrates an example cart magazine 206 loaded at an end of an example box former 140. In the depicted example, a cart magazine 206 has a full stack of carton blanks 204. The box former 140 is shown without any carton blanks 204 being processed thereon. The carton grabber 208 is shown above a top-most carton blank 204 in the magazine 206, for example, prior to moving the top-most carton blank 204 to a carton conveyance mechanism 210. Additional details of the carton grabber 208 and carton conveyance mechanism 210 are described in further detail elsewhere herein.

FIG. 5G illustrates the example cart magazine 206 in a zoomed in or expanded view to show additional detail. As illustrated, the cart magazine 206 may be configured to allow the carton blanks 204 to be moved separately from the cart. For instance, as described in further detail below, a lifter 564 of the box former 140 may extend between the cart and the carton blanks 204 to lift the carton blanks 204 upward without lifting the cart (although, in some implementations, it may also lift the cart or a separate magazine 206). A frame 402 of the magazine 206 may be open at a top to allow additional carton blanks 204 to be placed therein or removed therefrom. As shown in the example, the box former 140 may include a fence, rail, or bumper 542 that guides or holds the cart (e.g., a bumper 542 on a floor that guides the wheels) to a correct position at the box former 140 so that the carton blanks 204 may be used, such as where they are lifted off a bottom surface of the cart until a top-most carton blank 204 contacts a carton grabber 208, which is described in further detail below (e.g., in reference to FIG. 6M). As noted elsewhere herein, the box former 140 may detect, by a sensor or a received message (e.g., from a human interface device 108 or WES 102) that the magazine 206 holding carton blanks 204 is correctly positioned, which may be used as a trigger or condition for forming a box.

FIG. 5H illustrates an empty cart magazine 206 docked at the box former 140. For instance, the cart is positioned between bumpers 542 connected to the floor and/or the box former 140. Additionally, the cart may be configured with carton blank support surfaces 566 and/or a recess 568 to allow the lifter 564 to extend under the carton blanks 204. In other implementations, the carton grabber 208 may directly grab a carton blank 204 (e.g., by lowering into the magazine 206) and no lifter 564 may be used. In the depicted implementation, the lifter/carton blank lifter 564 lifts the carton blanks 204 without lifting the cart. For example, a blank 204 may be lifted above a top frame or surface of the cart magazine 206 so that its travel with the carton blank grabber 208 is reduced and loading time of each carton blank 204 is reduced. Other details for this and other implementations of a cart magazine 206 and lifter 564 are described elsewhere herein.

FIG. 5I illustrates an example lifter 564 coupled with a side of a box former 140. The lifter 564 may include one or more horizontal surfaces 576 extending horizontally to extend under a stack of carton blanks 204 (e.g., above a surface and/or in a recess 568 of a cart magazine 206), although other implementations are possible and contemplated herein. As described in further detail below, the horizontal lifting surface(s) 576 (e.g., of a lifter 564) may be coupled with a gas ram, linear actuator, screw drive, belt drive, or other mechanism. For example, as illustrated in the example of FIG. 5I, a horizontal lifting surface 576 is connected at the end to a vertical track 572 via a mounting plate 574 and track coupler(s). As described and illustrated in further detail below, the lifting surface 576 may be movable by a belt or chain coupled with a motor that lifts and/or lowers the lifting surface 576. Example details of this mechanism are described in further detail in reference to FIGS. 6K and 6L.

FIGS. 6A-6I illustrate various views and example components of the example box former 140. These features, implementations, and components may be used with any of the implementations described herein, although other implementations are possible and contemplated herein.

FIG. 6A illustrates an example box former 140 with the frame 402, conveyor 218, and other components omitted for clarity and discussion purposes. In the example, a carton blank 204 is shown having been removed from a top-mounted carton magazine 206. The top-mounted carton magazine 206 may include a frame 602, a pushing mechanism 604, and other components that push carton blanks 204 toward an end of the magazine 206. For instance, carton blanks 204 may be pushed forward by a spring-mounted pushing mechanism 604, a motor, gravity, or a carton grabber 208, for instance. As illustrated in FIG. 6A, one or more adhesive applicators 432 may be mounted (e.g., to a cross bar, frame, etc.) above the path taken by the carton blank 204 from the magazine 206 to the plunger assembly 216. For instance, the adhesive applicator 432 may detect a carton blank 204 (e.g., based on an optical sensor or position of a carton conveyance mechanism 210) and/or be instructed by an equipment controller 110 to spray or otherwise apply adhesive onto the surface of the carton blank 204 (e.g., near the outer edges, at contact points, as described elsewhere herein). For example, a glue gun may be mounted over the carton blank 204, so that it squirts glue onto the carton blank 204 before or as it is pushed into the forming well 212. As described below, the plunger assembly 216 and/or side walls of the forming well 212 may compress the adhesive between overlapping sheets of carton material to secure the box in an erected state. As shown in FIG. 6A, a partially folded box 608 is also shown below the plunger assembly 216.

FIGS. 6B and 6C illustrate an example box former 140 with various components omitted for clarity and discussion purposes. FIG. 6H also shows an example box former 140 without a magazine 206 and other components for clarity and discussion purposes.

As illustrated in FIG. 6B, a carton magazine 206 is empty, and no formed cartons 220 or carton blanks 204 are illustrated. As shown in the example, a carton grabber mechanism 208 may include pneumatic suction cups 622 mounted to a pivoting arm 624, which may be pivoted based on movement of a linear motor 626 or other mechanism. For instance, the linear motors 626 may pull on a plate 628 that swings the pivoting arm(s) 624 upward to match the angle (e.g., 45 degrees) of a next carton blank 204 (e.g., a sheet of die cut cardboard) in the magazine 206. The pneumatic suction cups 622 on the arm may pull the carton blank 204 downward as the pivoting arm(s) 624 swing downward. Accordingly, the carton grabber 208 may position the carton blank 204 on or between a carton track 404 and/or carton moving mechanism 210.

A carton moving mechanism 210 may slide the carton blank 204 horizontally along the carton tracks 404/lanes until the carton blank 204 is properly positioned (e.g., based on an adjustable stop or a sensor). As illustrated in FIG. 6C, the carton moving mechanism 210 may include a linear motor, motor driving a belt, or other mechanism that can translate the carton blank 204 horizontally. For instance, the carton conveyance mechanism 210 may include a vertical plate or pins 630 (e.g., mounted to a motor-driven belt or chain) that push a carton blank 204 horizontally; although other implementations are possible and contemplated herein.

FIG. 6C also illustrates a forming well 212 and a door 408 of the forming well 212 in an open position. Various guides 214 are also shown above or attached to the forming well 212. In the illustrated example, the guides 214 include wedges mounted at various heights, orientations, and positions horizontally. For example, different heights of guides 214 may be used to contact and thereby fold portions of a carton blank 204 (not shown in FIG. 6C) at different times/orders. The directions of the example wedges may encourage the carton material to fold in particular directions. Additionally, the guides may be adjustable horizontally (e.g., in an X-Y direction) to accommodate different sizes or configurations of cartons/boxes. These and other features are described in further detail below.

FIGS. 6D shows a front perspective view and 6E illustrates a left perspective view of an example forming well 212, forming guides 214, and pusher 406, where various components of a box former 140 are omitted for clarity and discussion purposes. A forming well 212 may be a rectangular or box shaped cavity below (although other directions are possible) a plunger assembly 216 (not shown in FIGS. 6D and 6E). The forming well 212 may include a floor and one or more walls (e.g., 2-4 walls). A forming well 212 may include a wall that moves, such as a well door 408 that pivots upward to allow a formed box 220 (not shown) to be removed from the forming well 212. For example, a (e.g., pneumatic, hydraulic, linear actuator, etc.) pusher 406 may push a portion of a back wall of the forming well 212 to push the formed box 220 out of the forming well 212. The opening/pivoting wall/door 408 may be moved by a pneumatic or hydraulic ram or other mechanism.

In some implementations, the forming well 212 may include one or more flexible walls 634 that are flexible and/or pivot or otherwise move. A flexible wall 634 may be coupled at the top and, in some implementations, may include a spring or gas ram to push it inward thereby allowing pressure to be applied to side walls of the carton. For example, a plunger assembly 216 may press outward on the carton side to compress layers of material against the flexible wall 634 and adhere the carton sides together.

The forming well 212 may be open at the top (as illustrated) and a carton blank 204 may be pushed through the top by a plunger assembly 216. One or more forming guides 214 may be mounted to one or more adjustable rails 636 at the top of the forming well 212, as described below.

FIG. 6F illustrates example adjustable rails 636 and sets of forming guides 214 mounted to the rails 636. For example, depending on the implementation, forming guides 214 may include angled tops, rounded, or wheeled tops that spread the force as a carton blank 204 is pushed through the forming guides 214. For example, as illustrated in the example, forming guides 214 may include rectangular shapes with angled tops, which may be adjustably mounted to rails or frames 402 (e.g., using mounting plates 574 and fasteners). The forming guides 214 may have various heights, angles, or other configurations to contact a carton blank 204 at various points. For instance, the heights of the guides 214 may be set so that some contact the carton blank 204 before others while the plunger is being actuated in order to control which sides of the carton blank 204 fold first.

For example, as illustrated, a first set of guides 214a may be taller and placed further out to perform a first stage fold. A second set of guides 214b may be mounted perpendicular to and lower than the first (214a) to fold a front/back of the box upward into a vertical position (e.g., perpendicular to a bottom of the carton/box). A third set of guides 214c may be positioned on the same sides as the first set (214a) but at a lower position to push an outer flap of the carton blank 204 upwards. The third set of guides 214c may be placed inward or outward of the first set 214a. Although each set of guides 214 is illustrated as having four members, one, two, three, or other quantities or configurations of guides 214 are possible.

The position of each rail 636 and/or the position of each guide 214 may be adjusted to move the guides 214 outward or inward away from/toward a center of the opening through which cartons pass. For instance, fasteners coupling the rails 636 together may be loosened and the rails 636 may be slid apart to form larger boxes. Similarly, the guides 214 themselves may be exchanged for different heights or sizes or they may be moved (slid, rotated, etc.) along the rails 636 to adjust for different box dimensions.

It should be noted that other sizes or configurations of rails 636 or guides 214 may additionally or alternatively be used. Additional details for how the carton folds as it is pushed through the guides 214 by the plunger 216 are described in further detail below.

FIG. 6G illustrates an example plunger assembly 216, which may be used to push a bottom surface of a carton blank 204 into a forming well 212. The assembly 216 may include a bottom plate 640 that may be smaller or the same size as a desired or configured bottom of a formed box 220 (not shown). In some implementations, the bottom plate 640 may be easily interchangeable to change a size of the box; although, a single size bottom plate 640 may be used with many sizes of box even though it doesn't match the edges of the box bottom, such as where the carton blanks 204 are previously scored, cut, or compressed to encourage the blanks to fold along defined lines.

The plunger assembly 216 or portion thereof (e.g., as illustrated in FIG. 6G) may move vertically in the box former 140, for example, as actuated by a linear actuator 642 or a hydraulic or pneumatic cylinder. In some implementations, moveable portion of the plunger assembly 216 may move vertically along a back plate 644 or frame (e.g., guided by an alignment guide 646), as actuated by a linear actuator 642.

In some implementations, near a bottom plate 640, the plunger assembly 216 may include one or more side pusher(s) 648 that may be electrically (e.g., using a linear actuator or a rotational motor with a cam or rack), pneumatically, hydraulically, or mechanically actuated (e.g., based on a pressure from the linear actuator 642 on a lever). The side pushers 648 may extend sideways outward to compress an inner flap(s) of the carton against an outer flap(s) of the carton, for example, to compress adhesive. For instance, the side pusher 648 may be extended outward once the carton is fully pushed downward into the forming well 212 by the plunger assembly 216. A side pusher 648 may exert pressure on a side wall of the forming well 212, which may be a flexible side wall 634. In implementations where the side pushers 648 are narrower than the box and extend outward (e.g., independently from plunger actuation) and a flexible side wall 634 is used, the probability that the walls or bottom of formed cartons will be deformed is reduced. In some instances, a flexible side wall 634 may additionally or alternatively actuate to apply pressure.

As illustrated elsewhere herein, the forming well 212 may also include a back wall and a front wall (e.g., a well door 408) that prevent sides of a box from moving as the adhesive is being set.

FIG. 6H illustrates a perspective view of portions of a box former 140. Like FIGS. 6B and 6C, portions of the box former 140 are omitted for clarity and discussion purposes. As illustrated in the example, a carton moving mechanism 210 may include a device that contacts or holds carton blanks 204 (not shown), which may include suction cups, graspers, friction devices, or, as illustrated in the example, it may include a movable wall or pins 630 that sit behind a carton blank 204 to push it toward a forming well 212. Adjustable bumper(s) 502 may be set so that the carton blank 204 stops when it is positioned correctly (e.g., for the size/configuration of the box). In the depicted example, the pins 630 of the carton moving mechanism 210 may move between components of the carton grabber 208 (e.g., suction cups, arms, frames, etc.). Although certain examples are shown, additional or alternative components, mechanisms, features, or implementations may be used.

Additionally, FIG. 6H illustrates an adhesive applicator 432 mounted above the path of a carton blank 204. In the depicted example, the adhesive applicator 432 may be a sprayer that is electronically or pneumatically actuated to cause adhesive to spray onto flaps of a carton blank 204. In some cases, there may be multiple adhesive applicators 432 that apply adhesive to different parts of a carton blank 204 simultaneously or sequentially. In some implementations, an adhesive applicator 432 may pivot or move downward (or upward depending on the orientation of the forming well 212) to contact or nearly contact a surface of the carton blank 204 and apply adhesive thereto.

FIG. 6I illustrates a portion of an example box former 140, for example, it shows a cart magazine 206 and a lifting mechanism 564 for moving the carton blanks 204 into the box former 140.

A cart magazine 206 may include a frame 402 or other support structure that supports a stack of carton blanks 204. The cart magazine 206 may include wheels/castors at the corners and one or more extensions configured to keep the carton blanks 204 aligned. In some implementations, the magazine 206 may not include wheels or may otherwise be transported and/or lifted by a forklift, AGV 114, dolly, separate cart, or otherwise. For example, when a sensor or human agent determines that the magazine 206 is empty, it may be replaced with a full magazine 206. For example, if a sensor coupled with the box former 140 determines that the magazine 206 is empty or below a threshold, the equipment controller 110 may send a message to the WES 102, WMS 104, and/or human interface system 108, which instructs an AGV 114 (e.g., via the REX 118) or a human agent (e.g., via the human interface system 108) to replace the magazine 206.

Once a magazine 206 is placed on the lifter 564 (e.g., the magazine 206, cart, or carton blank lifter 564), it may lock into place and/or be lifted by the lifter 564 until it reaches a height at which a top-most carton blank 204 is at or within reach of a carton grabber 208 (e.g., based on a stop or sensor indicating the height). For example, the lifter 564 may be coupled with a belt or chain that is driven by an electric motor, as discussed in further detail below. Alternatively, a linear or screw drive actuator, pneumatic or hydraulic ram, or another mechanism may be used to lift the magazine 206 and/or carton blanks 204.

A carton grabber 208 may be coupled to an overhead track 650 and may move along the track 650 to move the carton blanks 204 from the magazine 206. The carton grabber 208 may have a spring loaded or actuatable hook or other structure that pushes the back of a carton blank 204 off of the magazine 206, and/or the grabber 208 may include suction cups 622, friction pads, or other devices that allow it to apply force to individual carton blanks 204 to move the carton blanks 204. For example, the carton grabber 208 may move the carton blank 204 onto a carton track 404 and/or carton moving mechanism 210. In some implementations, the carton grabber 208, carton track 404, and/or carton moving mechanism 210 may be a single device or multiple separate devices.

As noted above, the carton moving mechanism 210 may include tracks 404, treads, conveyors, a linear actuator with a hook/finger, or other devices that push or otherwise position the carton blank 204 below the plunger assembly 216 and above the forming guides 214 and/or forming well 212. As noted elsewhere herein, the plunger assembly 216, forming guides 214, and forming well 212 may be in various orientations without departing form the scope of this disclosure.

FIG. 6J illustrates an example implementation of a cart magazine 206. Although other implementations are possible, a cart magazine 206 may include a base 654 with a frame that is static and/or adjustable to accommodate various sizes/configurations of carton blanks 204 or that includes adjustable portions that hold a stack of carton blanks 204.

The cart magazine 206 may include wheels at the corners, one or more carton blank support surfaces 656 that support carton blanks 204, one or more recesses 568 for receiving a carton blank lifter 564, and/or one or more vertical stabilizers 658 or frames. For example, two carton blank support surfaces 656 may be positioned apart to form a recess 568 or channel in which a horizontal lifting surface 576 of a lifter 564 fits. Similarly, the vertical stabilizers 658 or frames extend vertically from the cart base 654 to prevent the stack of carton blanks 204 from sliding off the cart. The vertical stabilizers 658 may be spaced to allow a horizontal lifting surface 576 of a lifter 564 to extend between them and/or move upwards to lift the carton blanks 204.

It should be noted that although the cart is illustrated as being constructed of extruded metal channels, it may have various constructions, materials, or configurations that are capable of moving a stack of carton blanks 204.

FIG. 6K illustrates an example cart magazine 206 located at a lifter 564 of a box former 140. A rear side of the lifter 564 is illustrated. For instance, on the rear side of the lifter 564, a motor, vertical track(s) 572, or other components may be mounted to a frame 402 of the box former 140. Similarly, the carton blank 204 grabber may be mounted to a horizontal track 650 above the lifter 564, so that it may more easily move a carton blank 204. For example, the lifter 564 may lift the carton blanks 204 upward from the magazine 206, so that a topmost carton blank 204 is within reach of the carton grabber 208. Components of the lifter 564 are described in further detail elsewhere herein.

FIG. 6L illustrates example components of a lifter 564 that lifts a cart magazine 206 and/or stack of carton blanks 204. For example, a lifting surface 576 (not visible) may be coupled with a vertical track 572 via one or more mounting plates 574 and one or more track coupler(s) 676. A belt 678 (or chain) may be coupled to the mounting plate 574, which belt extends over a top and bottom pully or wheel 680.

The motor 682 may be mounted to the vertical track 572 or another frame 402. The motor may include a gear, wheel, or pulley, for example, that couples it with the belt. In some implementations, one or more idler and/or tensioning wheels that route and/or tension the belt and/or allow adjustability. Accordingly, when an equipment controller 110 or other device (as noted elsewhere herein) instructs the motor 682 to rotate, it lifts or lowers a lifting surface 576 and thereby lifts one or more carton blanks 204. These may be lifted completely to interact with a carton grabber 208 (not shown in FIG. 6L) and/or the carton grabber 208 may lower or otherwise move to interact with the a (e.g., the topmost) carton blank 204.

FIG. 6M illustrates an example a carton grabber assembly 208, which may include an overhead track 650 with a carton blank interaction device 684. The track 650 may include or be coupled with an actuator (rotational motor, linear actuator, pneumatic or hydraulic ram, etc.) that moves that carton blank 204 interaction device 684 horizontally to move carton blanks 204 off a top (e.g., above a top-most portion) of the cart and onto the box former 140.

In some instances, the carton grabber 208 assembly, as shown, may include a vertical translator 686 that may include pneumatic, hydraulic, or electrical linear rams or other actuators, etc., that move the carton blank interaction device 684 upwards or downwards to interact with (e.g., push, drag, lift, or otherwise) a carton blank 204.

As illustrated in the example, the carton blank interaction device 684 may include one or more (e.g., 4 are illustrated) contact points 688 that are mounted to and extend downward from a frame 690. The contact points 688 may include adhesive or friction pads, suction cups, physical graspers, or other devices that grasp a top-most carton blank 204 to be able to lift and/or push it off the carton magazine 206/cart. The contact points 688 and/or the frame 402 may be adjustable to change contact points 688 and accommodate various sizes or configurations of boxes and/or magazines 206.

FIGS. 7A-7F illustrate example operations of the box former 140 in an example sequence, according to some implementations. Various frames and other components have been removed from these figures for increased clarity. As noted elsewhere herein, the described and/or illustrated features may be combined or interchanged with any other operations or features herein. Similarly, the features or operations may be omitted, reordered, augmented, or otherwise modified.

FIG. 7A illustrates an example box former 140 with a carton blank 204 having been removed from a magazine 206 (not shown) and moved on a carton moving mechanism 210. As it is moved under an adhesive applicator 432, adhesive may be applied to portions of the carton blank 204 that will contact other portions, as described elsewhere herein.

In FIG. 7B, the carton blank 204 has been moved by the carton moving mechanism 210 until a bottom (future bottom, once erected) portion of the carton blank 204 is below the bottom plate 640 of the plunger assembly 216 and above the forming guides 214 (not visible in FIG. 7B). For instance, the carton blank 204 may be moved until it contacts adjustable (e.g., positioned based on a size of the carton blank 204) end stops or bumpers 502 along the track 404.

In FIG. 7C, the carton blank 204 is pushed downward by the plunger assembly 216, so that the sides of the carton blank 204/box contact the forming guides 214, which cause the sides to fold in sequence.

In FIG. 7D, the carton sides have been completely pushed upwards as the plunger 216 has pushed the carton blank 204/box completely into the forming well 212. The side pushers 406 of the plunger assembly 216 and/or side walls of the forming well 212 may compress the folded sides to firmly adhere them together using applied adhesive.

For example, FIG. 7E shows the box 220 formed in the forming well 212 with the forming well 212 sides surrounding the box. In the depicted example the door 408 is closed and the plunger 216 is retracted.

FIG. 7F illustrates the well door 408 of the forming well 212 pivoted upwards and the carton pushed from the forming well 212 by a pusher 406.

FIGS. 8A-8E describe various example implementations of an improved box or shipping carton, which may correspond to the carton blank 204 and formed box 220 described elsewhere herein, although other implementations are possible. The example cartons may be used with the example box former 140 systems herein or with other box forming methods. Similarly, the example box former 140 systems herein may use other cartons or blanks.

FIG. 8A illustrates an example flat carton blank 804. The carton blank 804 may include die cuts that allow the carton blank 804 to fold with various flaps and along various lines. As shown elsewhere herein, the carton blank 804 may also include compressed or scored lines/creases that encourage the material to fold along certain creases. For instance, a sheet of corrugated cardboard may be stamped by a manufacturer to create creases and cuts. The stamped carton blanks 204 may be then stacked on a magazine 206 by the manufacturer or at a warehouse/fulfillment center. This simple manufacturing process significantly reduces the cost of the carton blanks 804 and, in turn, the boxes, and it allows the carton blanks 804 to be more compactly stored and quickly converted into formed erected boxes 820. For instance, past pre- manufactured boxes may be pre-adhered along a side or corner and then erected at a fulfillment center while the technology described herein allows the boxes 820 to be entirely formed at the fulfillment center.

Due to the double walls (e.g., where flaps are folded and adhered together) of certain portions of the carton/box and its configuration, in some implementations, thinner cardboard or other materials may be used, which further decreases cost.

Although various sizes and shapes of boxes are shown herein, it should be noted that the adjustable frames, guides, walls, stops, magazines, and other components of the technologies described herein allow the system to be easily varied for different sizes and/or shapes of boxes.

As shown in the example of FIG. 8B, a box is partially folded, as if it is partially pressed through sets of forming guides 214. As shown, a front and back wall 812a and 812b may be coupled with side flaps 814a, 814b, 814c, and 814d that extend fully or partially across the sides of the box when folded (e.g., each of the flaps 814 may extend halfway across the box, as illustrated). The box may also include sides 816a and 816b that are folded up on the outside or inside (depending on the implementation) of the side flaps 814. Once the side flaps 814 and side walls 816 are aligned, they may be pressed together to set the adhesive (located between them), or they may be taped, stapled, or otherwise. For example, adhesive may be applied to a top surface of the sides 816, so that it contacts the side flaps 814 of the front/back 812 when folded as shown in FIG. 8C.

Although other implementations are possible and contemplated herein, the front wall 812a and back wall 812b may each have side flaps 814a, 814b, 814c, and 814d, respectively, as illustrated.

The front 812a and back 812b may be joined by a bottom 810. Side walls 816 may also be connected to the bottom 810 (e.g., perpendicular to the front 812a and back 812b). For instance, side 816a and side 816b may each extend partially up the sides of the carton when folded (as illustrated in the example of FIG. 8C). Side 816a and side 816b may have adhesive pre-applied thereto or applied during assembly, as noted elsewhere herein.

In the depicted examples, the side flaps 814a-814d may be folded by forming guides 214 first, followed by the front 812a and back 812b and then followed by the sides 816a and 816b (although these steps may be performed in other orders and/or simultaneously). For example, as shown in FIG. 8C, side flaps 814a-814d may each extend halfway along the formed box 820 and the sides 816a and 816b may each extend partially (or fully) up the sides of the box and overlapping the side flaps 814. Accordingly, sides 816 and side flaps 814 may be adhered together (e.g., compressed using the side pushers and side walls of the forming well, as described above). It should be noted that the sides 816 may be located on the inside of the box or otherwise. Accordingly, a strong, light, simple box may be folded, formed, or erected in a single stroke of the plunger 216 through the guides 214.

In some implementations, front/back 812 walls and or side flaps 814 may be further cut and/or creased to create a box top when folded (e.g., as illustrated in the examples of FIGS. 8E and 8G). For instance, as shown in Figure C, a top may be formed using the portions 822a, 822b, 822c, 822d, 822e, and 822f, which may be folds (e.g., defined by a crease) in the front/back 812 and side flaps 814 (or sides 816). For example, a human agent, forming guide, robotic arm, or other component may fold the portions 822 and apply adhesive (e.g., tape), to close the box (e.g., for shipping).

FIGS. 8D-8G illustrate various configurations and example measurements for carton blanks 804 and resulting cartons/boxes 820; although, it should be noted that other implementations are possible and contemplated herein.

FIGS. 8D and 8E illustrate a first example carton blank 804a and formed carton 820a, respectively. These figures include example measurements and other configurations, although other implementations are possible and contemplated. As illustrated in the example carton blank 804a in FIG. 8D, various spacings lengths of cuts, spacing/sizes of cuts, directions, etc., may be used to form defined box sizes. In the illustrated example, the cuts may have a width of approximately on quarter inch to allow the carton blank 804a to easily fold, although other implementations are possible and contemplated herein.

FIG. 8E illustrates a perspective view 842a, side view 842b, and bottom-up view 842c of an example formed box 820a, which may correspond to that of FIG. 8D. For instance, the example of FIGS. 8D and 8E may result in a formed box 820a that has dimensions of 10 inches by 9 inches by 7 inches.

For example, as illustrated in FIG. 8D and 8F, a carton blank 804 may include a flat sheet of material, such as corrugated cardboard, plastic, or other materials. The material may be stamped, die cut, or otherwise to include perforations, cuts, creases, or other features.

In some implementations, a carton blank 804 may have a rectangular shape with a front edge, a back edge opposing the front edge, a left side edge extending between the front edge and the back edge, and a right side edge extending between the front edge and the back edge and opposing the left edge. As illustrated, the carton blank 804 may include two cuts starting on each of the back edge, front edge, left edge, and right edge and extending partially across the flat sheet of material to a plurality of end points, where each of the cuts having a separate end point, although other quantities and configurations are possible. In some implementations, as illustrated in the examples, the sheet of material may have a plurality of creases extending between at least two of the end points of the cuts.

Other implementations and variations are possible and contemplated herein, such as where side flaps are coupled with sides instead of a front and back, where a configuration of a top is different, or where the quantities and directions of cuts are varied. While various implementations are possible, they may allow forming guides and other structures to fold the sides, flaps, etc., in a defined way.

FIGS. 8F and 8G illustrate a second example carton blank 804b and formed carton 820b, respectively. The example in these figures provide another example size and configuration, although other sizes of cuts, folds, etc., are possible and contemplated, as noted above. Various example dimensions are provided in the carton blank 804a. FIG. 8G illustrates a perspective view 844a, side view 844b, and bottom-up view 844c of an example formed box 820b, which may correspond to that of FIG. 8F. For instance, the example of FIGS. 8D and 8E may result in a formed box 820a that has dimensions of 14 inches by 9 inches by 7 inches.

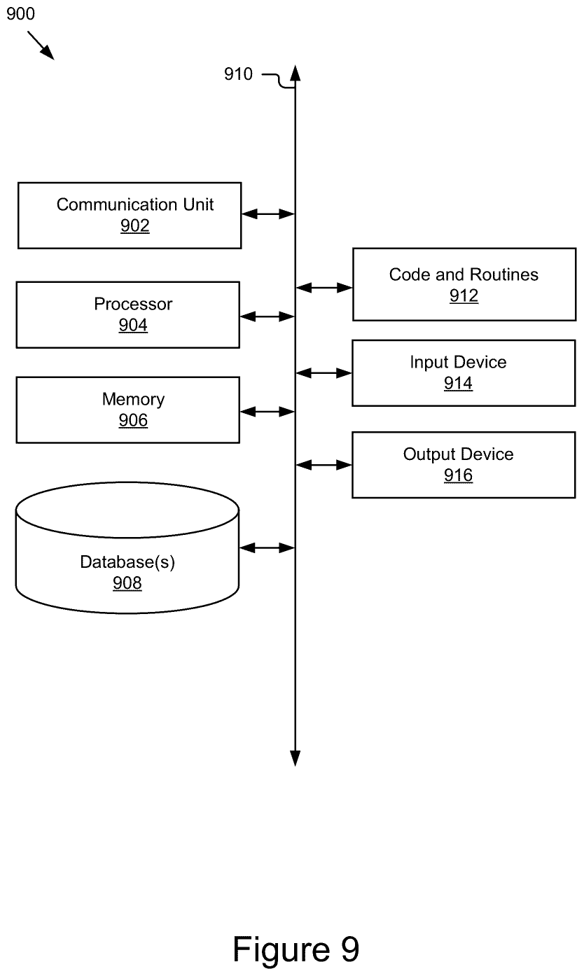

FIG. 9 is a block diagram illustrating an example computing system 900. The example computing system 900 may correspond to a WES 102, a WMS 104, a dispatch system 106, a human interface system 108, equipment controller(s) 110, REX server 118, a client device, a computing device of an automated carton erector 140, or other component of the system 100, for example. As described above, the system 900 may communicate with and/or control various components of the box former 140, for example, to implement the operations and automated methods described herein, although other implementations are possible.

The code and routines 912 may include computer logic executable by the processor 904 on a computing system 900 to provide for the functionality described in reference to one or more of the components of the system 100. For instance, in some implementations, the code and routines may include one or more of the components of the WES 102 or equipment controller(s) 110.

As depicted, the computing system 900 may include a processor 904, a memory 906, a communication unit 902, an output device 916, an input device 914, and database(s) 908, which may be communicatively coupled by a communication bus 910. The computing system 900 depicted in FIG. 9 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 900 may include various operating systems, sensors, additional processors, and other physical configurations. Although, for purposes of clarity, FIG. 9 only shows a single processor 904, memory 906, communication unit 902, etc., it should be understood that the computing system 900 may include a plurality of one or more of these components.

The processor 904 may execute software instructions by performing various input, logical, and/or mathematical operations. The processor 904 may have various computing architectures to process data signals including, for example, a complex instruction set computer (CISC) architecture, a reduced instruction set computer (RISC) architecture, and/or an architecture implementing a combination of instruction sets. The processor 904 may be physical and/or virtual, and it may include a single core or plurality of processing units and/or cores. In some implementations, the processor 904 may be capable of generating and providing electronic display signals to a display device, supporting the display of images, capturing and transmitting images, performing complex tasks including various types of feature extraction and sampling, etc. In some implementations, the processor 904 may be coupled to the memory 906 via the bus 910 to access data and instructions therefrom and store data therein. The bus 910 may couple the processor 904 to the other components of the computing system 900 including, for example, the memory 906, the communication unit 902, the input device 914, the output device 916, and the database(s) 908.

The memory 906 may store and provide access to data to the other components of the computing system 900. The memory 906 may be included in a single computing device or a plurality of computing devices. In some implementations, the memory 906 may store instructions and/or data that may be executed by the processor 904. For example, the memory 906 may store the code and routines 912. The memory 906 is also capable of storing other instructions and data, including, for example, an operating system, hardware drivers, other software applications, databases, etc. The memory 906 may be coupled to the bus 910 for communication with the processor 904 and the other components of computing system 900.

The memory 906 may include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor 904. In some implementations, the memory 906 may include one or more of volatile memory and non-volatile memory (e.g., RAM, ROM, hard disk, optical disk, etc.). It should be understood that the memory 906 may be a single device or may include multiple types of devices and configurations.

The bus 910 can include a communication bus for transferring data between components of a computing device or between computing devices, a network bus system including a network or portions thereof, a processor mesh, a combination thereof, etc. The software communication mechanism can include and/or facilitate, for example, inter-method communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The communication unit 902 may include one or more interface devices (I/F) for wired and wireless connectivity among the components of the system 100. For instance, the communication unit 902 may include various types of connectivity and interface options. The communication unit 902 may be coupled to the other components of the computing system 900 via the bus 910. The communication unit 902 may be electronically communicatively coupled to a network (e.g., wiredly, wirelessly, etc.). In some implementations, the communication unit 902 can link the processor 904 to a network, which may in turn be coupled to other processing systems. The communication unit 902 can provide other connections to a network and to other entities of the system 100 using various standard communication protocols.

The input device 914 may include any device for inputting information into the computing system 900. In some implementations, the input device 914 may include one or more peripheral devices. For example, the input device 914 may include a keyboard, a pointing device, microphone, an image/video capture device (e.g., camera), a touch-screen display integrated with the output device 916, optical scanner, barcode reader, QR™ code reader, RFID (radio-frequency identification) tag reader, etc.

The output device 916 may be any device capable of outputting information from the computing system 900. The output device 916 may include one or more of a display (LCD, OLED, etc.), a printer, a 3D printer, a haptic device, audio reproduction device, touch-screen display, etc. In some implementations, the output device is a display which may display electronic images and data output by the computing system 900 for presentation to a user, such as a picker or associate in the order fulfillment center. In some implementations, the computing system 900 may include a graphics adapter (not shown) for rendering and outputting the images and data for presentation on output device 916. The graphics adapter (not shown) may be a separate processing device including a separate processor and memory (not shown) or may be integrated with the processor 904 and memory 906.

The database(s) are information source(s) for storing and providing access to data. The data stored by the database(s) 908 may be organized and queried using various criteria including any type of data stored by them, such as the data in the data store 120 and other data discussed herein. The database(s) 908 may include file systems, data tables, documents, databases, or other organized collections of data. Examples of the types of data stored by the database(s) 908 may include the data described herein, for example, in reference to the data store 120.

The database(s) 908 may be included in the computing system 900 or in another computing system and/or storage system distinct from but coupled to or accessible by the computing system 900. The database(s) 908 can include one or more non-transitory computer-readable mediums for storing the data. In some implementations, the database(s) 908 may be incorporated with the memory 906 or may be distinct therefrom. In some implementations, the database(s) 908 may store data associated with a database management system (DBMS) operable on the computing system 900. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

It should be noted that the components described herein may be further delineated or changed without departing from the techniques described herein. For example, the processes described throughout this disclosure may be performed by fewer, additional, or different components.

It should be understood that the methods described herein are provided by way of example, and that variations and combinations of these methods, as well as other methods, are contemplated. For example, in some implementations, at least a portion of one or more of the methods represent various segments of one or more larger methods and may be concatenated or various steps of these methods may be combined to produce other methods which are encompassed by the present disclosure. Additionally, it should be understood that various operations in the methods are iterative, and thus repeated as many times as necessary generate the results described herein. Further the ordering of the operations in the methods is provided by way of example and it should be understood that various operations may occur earlier and/or later in the method without departing from the scope thereof.

In the above description, for purposes of explanation, numerous specific details are set forth in order to provide a thorough understanding of the present disclosure. However, it should be understood that the technology described herein can be practiced without these specific details in various cases. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self- consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms such as “processing,” “computing,” “calculating,” “determining,” “displaying,” or the like, refer to the action and methods of a computer system that manipulates and transforms data represented as physical (electronic) quantities within the computer system's registers and memories into other data similarly represented as physical quantities within the computer system memories or registers or other such information storage, transmission or display devices.

A data processing system suitable for storing and/or executing program code, such as the computing system and/or devices discussed herein, may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input or I/O devices can be coupled to the system either directly or through intervening I/O controllers. The data processing system may include an apparatus may be specially constructed for the required purposes, or it may comprise a general-purpose computer selectively activated or reconfigured by a computer program stored in the computer.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects may not be mandatory or significant, and the mechanisms that implement the specification or its features may have different names, divisions, and/or formats.

Furthermore, the modules, routines, features, attributes, methodologies, and other aspects of the disclosure can be implemented as software, hardware, firmware, or any combination of the foregoing. The technology can also take the form of a computer program product accessible from a computer-usable or computer-readable medium providing program code for use by or in connection with a computer or any instruction execution system. Wherever a component, an example of which is a module or engine, of the specification is implemented as software, the component can be implemented as a standalone program, as part of a larger program, as a plurality of separate programs, as a statically or dynamically linked library, as a kernel loadable module, as firmware, as resident software, as microcode, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A system comprising:
a carton blank dispensing device that holds a carton blank;
one or more carton moving devices that move the carton blank from the carton blank dispensing device and positions the carton blank between a plunger and a forming well;
the forming well including a floor, one or more walls, and an opening;
the plunger configured to move between a retracted position and one or more extended positions, the plunger contacting a top surface of the carton blank and pushing the carton blank into the forming well through the opening of the forming well; and
a set of forming guides positioned proximate to the opening of the forming well, the set of forming guides contacting one or more points on a bottom surface of the carton blank when it is pushed by the plunger, the bottom surface opposing the top surface of the carton blank.

2. The system of claim 1, wherein the carton blank dispensing device includes:
a magazine holding a plurality of carton blanks, each of the plurality of carton blanks including a flat sheet of material with a plurality of cuts along a periphery of the flat sheet of material.

3. The system of claim 1, wherein the one or more carton moving devices include:
a carton conveyance mechanism that translates the carton blank horizontally to a position between the plunger and the forming well.

4. The system of claim 3, wherein the one or more carton moving devices include:
a carton grabber that transports the carton blank from the carton blank dispensing device to the carton conveyance mechanism including extracting the carton blank from the carton blank dispensing device.

5. The system of claim 3, further comprising:
an adhesive applicator that applies adhesive to the carton blank when the carton blank is connected to the carton conveyance mechanism.

6. The system of claim 1, wherein the plunger includes:
an actuator that moves the plunger between the retracted position and the one or more extended positions;
a bottom plate that applies a force to the top surface of the carton blank; and
a side pusher that allows compression of one or more side walls of a carton formed by the carton blank while the formed carton is in the forming well.

7. The system of claim 1, wherein the set of forming guides includes:
a plurality of forming guides positioned proximate to the opening of the forming well, the plurality of forming guides contacting a plurality of points on the bottom surface of the carton blank.

8. The system of claim 7, wherein:
the plurality of forming guides are positioned at a plurality of heights above the floor of the forming well to contact the plurality of points at different vertical positions as the plunger moves from the retracted position to the one or more extended positions, the plunger pushing the top surface of the carton blank through the opening of the forming well.

9. The system of claim 7, wherein the one or more extended positions of the plunger include:
a first extended position causing the bottom surface of the carton blank to contact a first forming guide and causing a first fold in the carton blank; and
a second extended position causing the bottom surface of the carton blank to contact a second forming guide and causing a second fold in the carton blank.

10. The system of claim 7, wherein:
the plurality of forming guides have adjustable positions to allow the plurality of forming guides to fold different sized cartons using different configurations of carton blanks.

11. The system of claim 1, further comprising:
a pusher including a horizontally movable member that pushes a formed box out of the forming well, the formed box including the carton blank with one or more folds and an adhesive.

12. The system of claim 1, wherein the carton blank includes:
a flat sheet of material with a plurality of cuts along a periphery of the flat sheet of material.

13. The system of claim 12, wherein:
the flat sheet of material includes a zero folds when in the carton blank dispensing device.

14. A method comprising:
receiving a carton blank at a box former;
moving the carton blank to a position between a plunger and a forming well using one or more carton moving devices, the forming well including a floor, one or more walls, and an opening; and
folding the carton blank into a folded carton by moving the plunger between a retracted position and one or more extended positions including pushing the carton blank into the forming well through the opening of the forming well, a set of forming guides being positioned proximate to the opening of the forming well, the set of forming guides contacting one or more points on a bottom surface of the carton blank when a top surface of the carton blank is pushed by the plunger, the bottom surface opposing the top surface of the carton blank.

15. The method of claim 14, wherein folding the carton blank includes:
moving the plunger from a first extended position to push a top surface of the carton blank until a first forming guide contacts a first point on a bottom surface of the carton blank, the bottom surface of the carton blank opposing the top surface of the carton blank, the first forming guide pushing against the first point and causing one or more side flaps of the carton blank to fold.

16. The method of claim 15, wherein folding the carton blank includes:
moving the plunger to a second extended position to push the top surface of the carton blank until a second forming guide contacts a second point on the bottom surface of the carton blank, the second forming guide pushing against the second point and causing one or more of a front and a back coupled with the one or more side flaps of the carton blank to fold.

17. The method of claim 16, wherein folding the carton blank includes:
moving the plunger to a third extended position to push the top surface of the carton blank until a third forming guide contacts a third point on the bottom surface of the carton blank, the third forming guide pushing against the third point and causing one or more sides of the carton blank to fold.

18. The method of claim 14, further comprising:
applying adhesive to one or more surfaces of the carton blank; and
setting the adhesive by compressing the one or more surfaces of the carton blank when the carton blank is located in the forming well.

19. A carton blank comprising:
a flat sheet of material including:
a rectangular shape with a front edge, a back edge opposing the front edge, a left side edge extending between the front edge and the back edge, and a right side edge extending between the front edge and the back edge and opposing the left edge;
two cuts starting on each of the back edge, front edge, left edge, and right edge and extending partially across the flat sheet of material to a plurality of end points, each of the cuts having a separate end point; and
a plurality of creases extending between at least two of the end points of the cuts.

20. The carton blank of claim 19, wherein:
the material includes corrugated cardboard; and
the cuts are die cut into the corrugated cardboard.
